(19) United States
(12) Patent Application Publication
(10) Pub. No.: US 2004/0168341 A1
(43) Pub. Date: Sep. 2, 2004

(54) Methods for performing operations, a housing for such methods, and furnishings for such housing

(76) Inventors: Peter Mosborg Petersen, Arhus (DK); Jan Alexander Villadsen, Arhus (DK)

Correspondence Address: FOLEY AND LARDNER, SUITE 500, 3000 K STREET NW, WASHINGTON, DC, 20007, US

(21) Appl. No.: 10/472,391

(22) PCT Filed: Mar. 21, 2002
(86) PCT No.: PCT/DK02/00192

(30) Foreign Application Priority Data
Mar. 21, 2001 (DK) PA200100472

(51) Int. Cl. F26B 5/04

(52) U.S. Cl. 34/402

(57) ABSTRACT

The invention relates to a method for performing a function or an operation involving a material and/or a device, in particular a non-gaseous material such as a biological material or an electronic material subjected to an operation as a scientific investigation, a medical test or a handling during production, under a gaseous atmosphere in an inner chamber. The invention provides a new principle for avoiding contamination by gaseous materials, airborne particles and other contamination to an inner space, such as a workbench or working chamber, from an adjacent surrounding space such as the ambient atmosphere, or emigration of materials such as hazardous medical material, toxic substances or other pollution to the adjacent surrounding space from the inner space. A workbench is obtained fulfilling all the strictest requirements to a clean working chamber.

The invention relates to a method for performing a function or an operation involving a material and/or a device, in particular a non-gaseous material such as a biological material subjected to an operation as a scientific investigation, a medical test or a handling during production, under a gaseous atmosphere in an inner chamber. The invention also provides a new principle for avoiding contamination by gaseous materials, airborne particles and other contamination to an inner space, such as a workbench or working chamber, from an adjacent surrounding space such as the ambient atmosphere, or emigration of materials such as hazardous medical material, toxic substances or other pollution to the adjacent surrounding space from the inner space.

The invention also relates to a housing, in particular for transferring biological material from the adjacent surrounding space to the inner space while an operation involving other material is performed without contaminating the material in the inner space, such as a workbench, an incubator, or a workstation comprising one or several incubators in combination with a workspace or workbench.

In addition the invention relates to a garment, in particular a glove comprising a flexible double layered structure defining a space containing a gaseous and non-contaminated atmosphere, where said garment may be applied to or removed from the housing while an operation involving materials such as biological material is performed in the inner space without contaminating the inner space and the materials. Furthermore the invention relates to a garment box, in particular a garment box for a glove, being intended for placing in an aperture of a workbench and also where said garment box may be applied to or removed from the housing while an operation involving materials such as biological material is performed in the inner space without contaminating the inner space and the materials,

The invention is applicable in various fields where transfer of materials and/or devices from an inner space to an adjacent surrounding spacing such as the ambient atmosphere or from the adjacent surrounding space to an inner space is desired. One prior art example is document U.S. Pat. No. 3,251,139. Another prior art example is WO 94/19922 by the same inventors as the present patent application, and defining the closest state of the art.

### BACKGROUND OF THE INVENTION

Scientific groups have shown that various gas pressures may have an effect especially on reaction of immune cells towards tumour cells (J. Immunol. 138:550;1987), and more generally on the biological reaction forms of various cells (Science 257:401;1992, Nature 288:373;1980). Also, it has been shown by numerous scientific researchers that the presence or non-presence of various gases has an effect on the possibility of obtaining fertilisation when performing in vitro fertilisation (Nature 406:633;2000) and that when expanding stem cells such as bone marrow, specific gases under specific and very accurate and precise pressures and concentrations have to be present and fulfilled (Leukemia, 14:735;April 2000, British J. of Haematology, 108:424; February 2000).

Working with biological systems in which a determined gas partial pressure is to be maintained is extremely difficult if the materials used by the operation is to be treated properly and correct and if proper provision is to be made for the health of the system operator. Also, working with biological and other systems such as electronic systems and space systems in which determined very high level of antiseptic or even a-septic or even further sterile or in other way non-contaminated environment is to be established and maintained is difficult and often impossible to provide with the equipment such as work benches or laboratories available today.

It has been shown that even a moderate modification of the partial oxygen pressure of biological systems such as cells will influence the general functions of the cells and the physiological conditions in which the cells are examined. The natural environment concerning pO₂ for a fertilised egg and embryonic stem cells are low. It has been found that the natural environment for the most primitive stem cells in the bone-marrow sinuses are likely located in a very low pO₂ environment, (Biophysical J.: pp. 685-96, August 2001). Regulatory pathways has been shown being affected by the pO₂ environment and are important for e.g. satellite cell proliferation, execution of cell fate and parent muscle survival in culture, (J. Cell Physiologic 189: pp. 189-196, 2001). This entails that presently, the in vitro conditions under which various physiological cells function are investigated are not optimal for imitation of in vivo physiological conditions. It has also been discussed and shown, that just small amounts of contamination in production of electronic product and in the space industry will result in the materials being made or handled being useless and the operation being wasted. That means that valuable production is wasted or in worst case, if test, production or scientific experiments are being performed in space, the launching of the space shuttle being deemed to be wasted.

Furthermore, in connection with e.g. incubation for production of cells or cell products, the conditions which are optimal for the production may differ significantly from the environmental conditions e.g. with respect to oxygen, O₂, and/or nitrogen oxide, NO, partial pressure and with respect to the level of antiseptic, a-septic or even sterile conditions. In addition, in the presently used work benches, alternating and variable oxygen partial pressures will prevail which means that experiments performed therein will be subject to uncontrollable experimental variations with respect to a major parameter. Also, when transferring materials and/or devices to and from the working chamber through apertures in the walls of the working chamber and when supplying e.g. electrical power, gases and/or liquids for the operation and when supplying any means for communication between devices in the working chamber and the adjacent surrounding space, contamination occurs because of gasses or other substances migrating through the materials that the supply means are made of.

It would therefore be extremely valuable to have incubator walls, workbenches, and other equipment for biological and/or electronic and/or mechanical materials that make it possible to work with completely fixed gas parameters, temperature, humidity number of particles and with a very high level of antiseptic, a-septic or even sterile or in other way non-contaminated environment during the entire experiments and the operations performed on the materials and performed by means of the devices in the working chamber. It would be valuable that inside the working chamber a number of small incubators with an atmosphere similar to or different from the atmosphere in the working chamber so that different phases of cell development can be studied at the same time. An example of such a process can be within the field of fertilisation where IVM (in vitro maturation), IVF (in vitro fertilisation) and IVC (in vitro cultivation) can take place. It would also be highly valuable to have stations in which incubators and workbenches are coupled such that all handling of material takes place at constant gas partial pressure and at the same level of antiseptic, a-septic or even sterile and non-contaminated environment without any safety hazards such as contamination to or from the surrounding environment.

In e.g. hospitals where patients are subjected to general anaesthesia, the environment of the patient is often contaminated by the volatile anaesthetics, resulting in a considerable risk of endangering the health of the hospital personnel working in the field of surgery. A Swedish national register study, (March 2001 by M.D. Neurologist Ann-Marie Lindtblom, University hospital of Linköping, Sweden), points at the risk for anaesthetic personnel for developing Multiple Sclerosis is twice as big as compared with two other groups: stewardesses and female teachers. Therefore, avoiding escape of gases from the anaesthetic equipment to the environment would be desirable. Also, avoiding ingress of contamination is of course also desirable. However, today no method of both avoiding the escape of gases and avoiding the ingress of contamination is available. Thus, by the present invention, when being able to fully control partial and total gas pressures of selected gasses and at the same time ensuring any high level of non-contamination, not only an antiseptic environment but even an a-septic environment or even further a sterile environment may be established together with a very low level of contamination of other substances than microbes, since infections combined with anaesthetic gases also might be important for the development of diseases such as e.g. systemic sclerosis.

Furthermore, within the welding and electronics industry (e.g. microchips, nano-technology and production of batteries such as lithium/cadmium batteries), it is often desired to operate with a determined gas partial pressure when working with specific materials such as, e.g., silver, silicium, aluminium, lithium and copper or alloys of these. Also, in other fields or the same fields of the electronics industry it is desired to obtain an extremely high level of non-contamination, The present invention makes it possible to obtain a protection, not only of the operator himself and against contamination of noxious gases and other contaminating substances to the environment, but also of the processed material against active oxygenating gases and contamination from the environment.

Even further, within the space industry and in space shuttles and space stations, more and more research and operations are being performed in order to take advantage of the environment in space in relation to the non-existence of any man-made contamination in space and the lower gravity or the weightlessness in space. However, other kinds of contamination may be present in outer space, which may influence the operations taking place either within a space shuttle or outside the space shuttle in outer space itself. The present invention makes it possible to obtain the demanded level of antiseptic, a-septic or even sterile and in other way non-polluted environment in order to fulfil the desired level of containment, even as high as third level of containment as defined by the space industry so that operations may be performed without influence of any contamination and/or pollution and by preserving desired partial and total gas pressures of selected gasses.

It appears from the explanation given above that it is desirable to obtain specific conditions within an inner chamber with respect to the total gas pressure of a gas, or with respect to the ratio of two or more gas species, and at the same time obtain specific conditions within the inner chamber with respect to the amount of contamination present in a flow bench, fume box, sterile box or other working chambers.

As a preferred application of the present invention, in experimental and commercial work with biological material such as cell cultures, especially for the production of patient specific cells, tissue or organs, normative cell lines, bacteria, spores, virus, biologic or synthetic DNA or RNA, production of vaccines, etc. it is important that the environmental, physical conditions can be controlled in order to secure the most favourable conditions for the experimental or commercial work. Accordingly, in some experimental or physiological situations, it is desirable to keep the conditions on extreme levels compared to the natural environment of the biological material or compared to the normal environment wherein the experiment is performed. In other situations, it is of importance to keep the experimental or production conditions within very narrow limits. The control of known variable parameters when working with biological material is a desirable and important task since the consequence of even small differences in each experimental or production trial might lead to an increased variation within the results and more data will therefore be needed to obtain the same statistical evidence from the results or that e.g. the needed governmental approval of the process for the production of patient specific biological material cannot be achieved.

When working with biological material in the laboratory, various attempts have been made to achieve desired physical conditions with respect to partial gas pressure of a gas species, with respect to total gas pressure and with respect to level of contamination. Until now, it has not been possible in the one and same working chamber to obtain the desired partial and total gas pressures together with obtaining a certain low level of contamination. Either the partial and total gas pressure is established according to desired conditions or a desired low level of contamination is established. The reason why it is not possible to obtain both the desired partial and total gas pressure and the desired low level of contamination at the same time in the one and same working chamber is because of the difference in obtaining the desired physical conditions with respect to the gas pressure and in providing means for handling the materials and/or devices and for transferring these to and from the working chamber with respect to the level of contamination.

On the one hand, in order to obtain a desired gas pressure, it is necessary to have tubes or pipes connected to the working chamber in order to provide the working chamber with the selected gasses and in order to adjust the gas pressures of the selected gasses. However, this results in connections being made in the walls of the working chamber. Thereby, substances may migrate through the connections and contaminate the inner space. On the other hand, in order to obtain a desired low amount of contamination, it is necessary to totally seal the working chamber. This makes it impossible or at least extremely difficult to also provide the working chamber with selected gases under desired gas pressures and to transfer materials and devices needed for the operation to take place in the working chamber.

Thus, there is a discrepancy between on the one hand providing selected gases, adjusting their partial pressures in the working chamber together with transferring materials and/or devices to and from the working chamber and on the other hand obtaining and maintaining an environment with a certain low level of contamination, preferably an a-septic or even sterile environment as specified in the medical industry or an environment corresponding to a third level of containment as specified in the space industry. The separation between the workspace and the surrounding space is established by means of a number of walls, the main part of which may be made of a material which is substantially impermeable to gas and impermeable to any contamination. However, it is almost impossible to seal the workspace completely to gases and contamination present in the surrounding space because it is normally necessary to transfer materials and/or devices to and from the working chamber, and to handle the material in the working chamber, thus necessitating the use of transparent polymeric materials through which many gasses are able to diffuse. Also, various types of lead-ins supply, gas exchange etc. are needed for a sufficient handling of the material within the workspace, but such lead-ins tend to allow at least a certain mixing of gas present within the workspace and gas present in the environment. The lead-ins may also constitute means of migration for some kinds of contamination.

The most effective way to obtain a tight workspace is by use of an inner space having walls consisting of stainless steel wherein all connections of the steel are welded, whereby only a minimal gas transport through the walls is possible. However, for all practical uses, such a construction will not fulfil the normal requirements for transferring materials and/or devices and for handling the material in the chamber at a reasonable level. Lead-ins will still be required and cannot be completely gas-tight, and a solid stainless steel wall cannot possibly comprise a transparent wall allowing inspection of the workspace. From this it appears that leads, connections or welded part should preferably not be present in such wall parts. Accordingly, the person skilled in the art has to face some defiencies in known work benches, defiencies which the person has to accept and which limits the possible performing of operations or at least reduce the probability of the operations performed leading to a successful result every time the operations are performed.

U.S. Pat. No. 4,026,286 describes an isolator is disclosed wherein an isolated environment at a higher pressure than the ambient environment has a transfer port which comprises a flexible sleeve leading from an opening in the isolator. The purpose of the sleeve is to produce a substantially planar non-turbulent flow in the air leaving the isolator through the opening whereby un-sterilised air flowing back to the isolator is avoided. Thus, when working in practice with a positive gas pressure in the workspace, there is a considerable risk of contamination of the surrounding environment and the persons working in the surroundings by the gases or by airborne particles deriving from with the material handled in the workspace. By using a negative pressure in the workspace, the risk of contamination of the surrounding environment is avoided; however, there is an increased risk of contamination from the environment to the material to be handled in the working chamber.

GB 1 201 748 describes a transfer lock is disclosed comprising a sealing-tight chamber, which is closed by two removable doors, an inner door connecting the vessel with the lock chamber and an outer door connecting the lock chamber to an external region outside the vessel. The transfer lock comprises a scavenging air ventilation circuit whose output directly supplies the vessel. In order to convey products from the vessel, firstly one door is drawn back so as to connect the vessel interior with the lock chamber. The products are conveyed to the lock chamber and the scavenging air prevents any pollution of the lock chamber. Thereafter, the inner door is locked, and the outer door is drawn back so as to connect the lock chamber with the external region so that the products may be conveyed our of the lock chamber. In order to convey products to the vessel, the outer door is drawn back in order to connect the external region with the lock chamber. Thereafter, the outer door is locked and the inner door is drawn back. The scavenging air prevents any pollution from the lock chamber from entering the vessel.

WO 94/19922, as mentioned describing prior art formerly developed by the same inventors as the inventors of the present invention, describes a work bench having a working chamber surrounded by first walls and second walls surrounding the first walls. Thereby, a second chamber is established, totally surrounding the working chamber. In the walls of the working chamber and the walls of the second chamber, doors similar to those described in the above-mentioned GB-publications are provided. Thus, a sealing-tight chamber is also established constituted by the second chamber. Transfer of products or materials to and from the working chamber takes place the same ways as described in the above-mentioned GB-publication. Accordingly, the doors have to be opened and closed in a certain manner in order not to contaminate the working chamber and in order not to having substances from the working chamber escaping. The opening and closing of the doors also have to be performed very carefully and properly, so that none of the mentioned risks are present.

U.S. Pat. No. 5,022,794 describes a tight insulator is disclosed from which it is possible to rapidly discharge objects under an overpressure by placing the object in a discharge tube and opening a door sealing the discharge tube, whereby an air flow is directed through the tube towards the outside of the insulator as a result of the overpressure within the insulator, thus counteracting entry of air from the outside into the incubator; a further measure against such entry of air is suction from an exhaust pipe connected to the discharge tube and creating a suction action in the immediate vicinity of the door. A procedure parallel thereto for inserting objects rapidly into an insulator under vacuum by use of an introduction tube connected to a ventilation circuit is also suggested in the patent.

GB 2 336 409 describes a transfer apparatus with a carousel for transferring materials from an outer environment to a housing. The transfer takes place through the carrousel sequentially by means of the carousel rotating between different stations where firstly most of the environmental gas is evacuated and secondly any cleansing gas is added. The carousel is provided with sealing seals being slidably in contact with inside walls of the housing. The sliding, however, induces the risk of impurities being dragged along with the seals. Furthermore, the seals will be worn every time the sliding takes place, also increasing the risk of impurities being admitted to the intermediate stations and to the inner housing. Accordingly, the demand for a clean environment in the housing is dependent on the present condition of and the control of the seals.

When working with a negative pressure chamber as described above the present inventors have experienced that in situations wherein a low oxygen partial pressure is desired it is only possible to obtain a constant oxygen partial pressure down to 3 kPa since gases from the surroundings will diffuse towards the working space. If the operation cost are to be kept at a reasonable level, it is only possible to maintain a constant oxygen partial pressure down to 6-7 kPa. Furthermore, although incubators where oxygen tension can be set and kept at values down to about 3 kPa exist on the market, the necessary opening of the incubators for inserting, removal or handling of material such as cultures and other substances immediately results in the oxygen pressure of ambient air and thereby causes a rapid re-oxygenation of the cells, tissue or organs and in this manner causes production of oxygen scavengers such as H₂O₂, O₃ etc.

When the necessary opening of the incubators or bioreactors when transferring material and/or devices during insertion into or removal from the working chamber, the risk of contamination is very high. Because of the necessity in incubators existing on the market for a correct and proper opening and closing of two doors between the working chamber and the adjacent surrounding space, there are a severe risk of one or both of the doors being incorrectly or not properly opened or closed. This results in that the cells might be harmed by possible contamination and the biological process not succeeding or the biological process and the resulting biological material being subject to uncertainty and therefore having to be disposed of. Using bioreactors often requires that the cells are non-adhesive, tissue and organs cannot be processed in such bioreactor and the minimum cellular volume required often can't be achieved.

It has been shown by numerous scientific researchers that the presence or non-presence of various gases has an effect on the possibility of obtaining fertilisation when performing in vitro fertilisation and that when expanding stem cells such as bone marrow, specific gases under specific and very accurate and precise pressures and concentrations have to be present and fulfilled.

There is an increasing awareness in research of the importance of growing and handling biological cellular material (in vitro or more correct ex vivo) in a gaseous habitat similar to that which the specific cell population encounter in the living organism (in vivo), in both normal and pathological situations. The intention is more precisely to mimic the in vivo situation and to avoid the fluctuation in gas tensions when taking cells in and out of conventional incubators. Furthermore, in the developing field of biotechnology and bioengineering there is a need of procedures that can help to develop better and more suitable products. In this aspect oxygen is a very important gas.

The specific oxygen tension influences such diverse cellular functions as e.g. gene expression, cellular secretion/production, cellular proliferation/differentiation, tumour growth, embryogenesis, and haematopoiesis. Oxygen is required for the survival of all higher life forms due to its central role as the final acceptor of electrons in the mitochondria respiratory chain, thus making possible the synthesis of ATP by oxidative phosphorylation. However, oxygen is an inherent challenge to aerobic life and cells have adapted different protecting mechanisms against free oxygen which is potential lethal to cells. Therefore, the function and expression of a specific cell population is very dependent of the specific oxygen tension in which it is investigated. Specific cell populations in the living organism are adapted/differentiated/selected to the specific physiological oxygen tension of the particular tissue.

The investigation of cellular processes ex vivo has by tradition/convention been done at ambient oxygen tension (20%). The main focuses have mainly been on maintaining the temperature humidity and, pH in the media correct. However, recent research has shown that the cells in living organism exist at much lover oxygen tension (varying dependent of cell type and organ from 2-14%, (2-14 kPa 02), with a medium tissue oxygen tension around 5%). Therefore, it is important to note that 5% oxygen is close to the physiological oxygen tension of many tissues, whereas the percentage of oxygen usually employed for most ex vivo methods is atmospheric oxygen tension (20%).

A guiding principle for the development of methods for ex vivo cultivation of human and other mammalian cells has been to create conditions, e.g. temperature, pH, humidity, osmolarity, growth factors, etc., which as closely as possible imitate the in vivo environment of the cells in question. The oxygen tension is here a noticeable exception, as nearly all ex vivo studies of cell biology, virology, immunology, etc. are carried out in equilibrium with ambient atmosphere. This ambient oxygen tension is several times higher than that found in vivo, which results in aberrations in the metabolism of cells grown ex vivo. The reason for neglecting this factor in most ex vivo work is the unproved assumption that it does not change the cell phenotype in any significant way, and the fact that it is technically difficult to carry out handlings of the cells and at the same time keep oxygen tensions at stable, prefixed in vivo physiological levels.

Related to this is the lack of understanding of the fact that not only does the cell phenotype change when the oxygen tension is lowered from that of ambient atmosphere to in vivo physiological levels, but it changes further if the tension is even moderately reduced to below the physiological level. The physiology of anoxia has been, and is being, extensively studied, but the consequences of changes in the oxygen tension within the span between the physiological levels and the zone from low physiological to the pathological low levels of infectious, cirrhotic or tumourous tissue is ignored in most branches of biology.

In the last years, specific scientific attention has been focused on optimising cord blood stem cell ex vivo expansion in order to enhance the success rate of stem cell transplantation. Attention has also been on enhancing the success rate of in vitro fertilisation. In both areas it has recently been found that cultivating the cells at physiological oxygen tensions of 5% enhances the expansion rate of the cells.

In the future there seems to be a promise that culturing human tissues and organs on the basis of a ceIl taken from the person set to receive the organ, one of the great problems involved in transplantation from both other humans and animals would have been surmounted, i.e. the rejection of foreign tissue.

Cloning research has shown that cells from the human organism can be reprogrammed by the mature egg cell. Research is now going on into undertaking the entire reprogramming of the cell in a petri dish, which calls for a knowledge of what it is that makes cells specialise into e.g. a heart muscle cell. Something about these processes is known today and in some cases the process can be controlled in a. petri dish or differentiation can be allowed to take place of its own accord, in order to then select the type of cell on which it is wished to continue the culture. Even now, then, it is possible to cultivate blood vessels that can be used for e.g. bypass operations on the heart.

Minor organs can also be cultivated in a three-dimensional structure by growing the cells on special scaffolds made of biodegradable materials. The scaffold is thereby degraded slowly, vanishing entirely once the cells have grown into it. In this way cartilage has been cultivated in the shape of meniscus, ears and noses and connective tissue in the shape of heart valves. But if, in addition to the 3D structure, it is also wished to have several different types of cells align properly, as is necessary for example to cultivate a large organ such as a kidney or a liver, then problems arise. This possibility has a longer future perspective.

One possibility being researched into to solve the problem is to insert the reset cell nucleus into an egg cell and produce a premature foetus. A private American company, Advanced Cell Technologies, has publicised the fact that it has reset a somatic cell from a human and inserted it into the evacuated egg cell of a cow (using cow's eggs is desirable because gaining access to women's eggs is very difficult and involves ethical problems). In order to be able to engineer something as complex as an entire organ, it is envisaged that the handled egg cell will need to be placed in a uterus/specialised incubator for a period of time while the organ is being constructed (4-8 weeks), subsequently removing the foetus and then continuing to engineer the organ in the laboratory.

Based upon the above-mentioned possibilities, there is an awakening realisation that improvements have to be made concerning the way ex vivo tissue culturing is carried out. Over the last few years, groups all over the world have started using incubators with adjustable oxygen tension, but still handle the cells in the presence of the ambient atmosphere of their flow benches, thus exposing them to the uncontrolled stress of sudden changes between normoxia and hyperoxia and back. The problem also goes beyond pure research. Drug companies' in vitro testing for e.g. toxicity can be flawed by un-physiological oxygen tensions.

### DESCRIPTION OF THE INVENTION

According to a first principle, the present invention relates to an inner space such as a housing which is separated from the environment of the inner space by walls of the inner space and which walls permit establishing and controlling or maintaining different gas conditions and anti-septic, or even a-septic levels or even further sterile conditions between the inner space and the environment both with respect to the gas composition and gas pressure, with respect to exchange of gas between the interior of the inner space and the environment, and which walls with respect to migration of contamination between the inner space and the environment, and where transit means are provided both in walls of the inner space and in walls of the intermediate space for transferring materials and/or devices from the environment through the walls of the inner space and into the inner space.

According to a second principle, the present invention relates to an inner space such as a housing which is separated from the environment of the inner space by an intermediate space which substantially encloses the inner space and which intermediate space permits establishing and controlling or maintaining different gas conditions and pollution levels between the inner space and the environment both with respect to the gas composition and gas pressure, with respect to exchange of gas between the interior of the inner space and the environment, and with respect to migration of contaminants between the inner space and the environment, and where transit means are provided both in walls of the inner space and in walls of the intermediate space for transferring materials and/or devices from the environment through the walls of the intermediate space and further through the walls of the inner space into the inner space.

In the present specification and claims, the term “substantially encloses” or “substantially enclosing” indicates that the intermediate space encloses the inner space substantially completely, and preferably completely, with the exception of areas where the walls of the inner space and the walls of the intermediate space is provided with transit means for transferring materials and/or devices from the adjacent surrounding space to the inner space and vice versa. The transit means is of such a character that in practice it is tight for all relevant gases under the relevant conditions of use and where, accordingly, the intermediate space would not contribute to controlling or maintaining a desired gaseous atmosphere in the inner space in accordance with the principles disclosed herein. In practice, such gas-tight wall parts would be wall parts made in a construction and of a material, which is practically impermeable to gases present in the inner chamber or to gases and any contamination present in the adjacent surrounding space.

The intermediate space is constituted by walls of the inner space and walls of the intermediate space, said walls separating the intermediate space from the adjacent surrounding space. The walls of the intermediate space and the walls of the inner space may be provided with couplings for leads, tubes, pipes and the like between the adjacent surrounding space and the inner space. The intermediate space itself may also be equipped with lead-ins and lead-outs for the supply and removal of gas, electricity, light, electromagnetic signals, radio and TV signals etc. and with means for measuring the content of gases and means for adjusting gas pressure in the intermediate space, means for measuring the transmittal of electricity and light, means for transmitting and receiving radio and TV signals etc.

The inner chamber establishing the the, and which inner space is substantially enclosed by the intermediate space, may also be equipped with means for measuring total gas pressure and/or the partial pressure or concentration of a gas species content and means for adjusting the total gas pressure or the partial pressure or concentration of a gas species, e.g. in the response to the measurements by the measuring means, whereby a desired total gas pressure or a desired partial pressure of a selected gas species can be obtained and maintained in the workspace.

In the present specification and claims, the term “workspace” or “working chamber” designates the space/room in which an operation, that is any handling during work, experiment, incubation, test, process etc. cf. the discussion of the term “operation” below, is carried out, this being, in the cases relevant to the invention, at a particular given or predetermined gas partial pressure or gas composition and/or at a given predetermined pollution level or generally low level of contamination which are different from the adjacent surrounding space perhaps being the ambient atmosphere.

Thus, there is no undesired or uncontrollable diffusion or flow of gases between the workspace in the housing and the adjacent surrounding space but only from the workspace in the housing to the intermediate space, and from the adjacent surrounding space to the intermediate space, respectively. Also, there is no undesired or uncontrolled migration of contamination between the workspace in the housing and the adjacent surrounding space, but only possible migration of contamination either from the workspace to an inner surface of the inner wall of the intermediate space being the wall to the inner space, or possible migration contamination within the intermediate space between the inner wall and the outer wall of the intermediate space, and possible migration of contamination from the adjacent surrounding space to an outer surface of the outer wall of the intermediate space, respectively. There is absolutely no migration of contamination from the inner space to the adjacent surrounding space, and vice versa.

One use of the invention is preventing undesired gas combinations, such as explosive compositions, to occur within a space by separating the space from a surrounding space by an intermediate space and, as mentioned above, preventing undesired mixing of gases or controlling the ratios of the gas species present in a gas mixture within the working place or in the double wall according to the above principle.

In the present specification and claims, the term “gas pressure” refers to total gas pressure as well as partial gas pressure of a gas species if not otherwise specified. A partial gas pressure of a gas species is the pressure of the gas species in a gas mixture, which the gas species would create if it were the sole gas species present in the same volume as the gas mixture. The total gas pressure of a gas (gas mixture) is the sum of the partial gas pressures of the all gas species present in the gas (the gas mixture).

The term “a number of gases” is intended to designate one or several gas flows or rather one or more gases from one or more gas supplies, each of which may be provided either as a mixture of gas species or substantially pure gas species; in other words, in the present specification and claims, the term “gas” is distinct from “gas species”.

Another use of the invention is preventing undesired pollution, such as septic substances within the medical industry or other contaminating substances within other industries such as the electronic industry or the space industry, to occur within a space by separating the space from a surrounding space by transit means and preventing undesired contamination of the inner space or controlling the migration of contamination present in the adjacent surrounding space from the surrounding space to the inner space or from the intermediate chamber to the inner space according to the above principle.

In the present specification and claims, the term “contamination” refers to any undesired substance in gaseous, liquid or solid state and of any kind such as common contamination like dust, specific contamination like micro-organisms, and with respect to a specific operation within the inner space specific contamination like a wrong or undesired ratio between a total gas pressure in relation to a partial gas pressure of a specific gas species, a wrong combination of gases, a non-desired contaminating substance or other kinds of contamination of the inner space.

Equipment for working with low partial pressures of gas species which are also present in the atmosphere, shows that no space can be established in such a way that the space is completely gas-tight, while at the same time being capable of transferring materials and/or devices from the adjacent surrounding space to the workspace , and vice versa, and still prevent contamination of the space when the materials and/or devices are being transferred between the surrounding space and the inner-space. Furthermore, when leads, tubes and pipes are being led through the walls of at least the inner space and preferably also through the walls of the intermediate space, gaseous contamination may migrate along the barrier which the material of the leads, tubes and pies constitute or diffuse through any other barriers such as membranes, gaskets or garments provided in the walls and penetrating the walls.

By establishing, in accordance with the first principle of the invention, at least a single wall or a plurality of walls being impermeable to any migration of contaminating substances, and by establishing transit means in the shape of an air lock through the wall or walls between the adjacent surrounding space and the inner space, that is capable of preventing contamination, mostly in a gaseous phase, from entering the inner space, the diffusion constant for the diffusion of a gas species through such a wall with transit means can now be subjected to an active adjustment resulting in a reduced diffusion constant and a maintenance of a limited possibility of migration of contamination through the wall. Keeping the connections of the transit means between the adjacent surrounding space and an outer surface of the wall and between the inner space and an inner surface of the wall impermeable to migration of contamination contributes to a substantially increased level of non-contamination and to a possibility of controlling, adjusting and maintaining a certain level of contamination.

By establishing, in accordance with the second principle of the invention, a wall consisting of a combination of a solid phase being the outer wall of the intermediate space, a gaseous phase being the intermediate space, and a second solid phase being the inner wall of the intermediate space, the diffusion constant for the diffusion of a gas species through such a wall can now be subjected to an active adjustment resulting in a reduced diffusion constant when maintaining a low concentration of the gas species within the gaseous phase of the wall. Keeping the partial pressure of the gas species in the spaces, which the wall separates, contributes to a decreased diffusion of the gas species across the wall.

In the present context, the term “operation” is to be understood in a broad sense and thus includes any handling of and interaction with the material in question, whether this is a physical handling or interaction or a biological interaction or handling, as well as culturing cells in a culturing medium or just keeping a material under the gas pressure conditions in question. Thus, any kind of operation, which takes place in the above-mentioned incubators, flow benches and workbenches is included. However, a most important feature of the invention is that it permits physical interaction, including tactile interaction, such as handling, with the material.

Handling can be directly manual by an operator via an interface of a glove-like type, such as illustrated in the drawings, or another interface which may or may not have a particular shape or conformation which allows handling with the interface interposed between the operator and the material to be handled. Interfaces, which have special shapes or conformations, can be in the shape of more or less complete garments or garment parts, normally including glove parts. The physical, in particular tactile, interaction can also be interaction via a robot or other automated and/or controllable handling equipment.

In embodiments comprising an intermediate space constituting a gaseous wall according to the second principle of the invention, the gaseous atmosphere of the adjacent surrounding space is often and preferably the ambient atmosphere, either the outer atmosphere in a non-conditioned room or a controlled atmosphere in a laboratory or the surroundings in outer space, so that the outer wall of the intermediate space is the delimitation of the system in question against the adjacent surrounding space, e.g. in a laboratory, in a factory, or inside or outside a space shuttle.

### BRIEF DESCRIPTION OF THE DRAWINGS

The invention will be further described with reference to the drawings, where

FIG. 1 is a perspective view of a possible and preferred embodiment of an apparatus according to the invention being a workbench with a first and a second chamber,

FIG. 2 is a diagram of a system for controlling, adjusting and maintaining certain partial and total gas pressures in the working chamber and the intermediate chamber,

FIG. 3 are a view with a carrousel being part of a transit means constituting an air lock between the first chamber and an adjacent surrounding space,

FIG. 4A-4C are views of other transit means for transferring electrical power, fluids, signals or optical views between the first chamber and an adjacent surrounding space,

FIG. 5A-5H show different furnishings to be used in the housing, the furnishing being shelves, a table and casings constituting incubators,

FIG. 6A-6B are photographs showing the inside of a first chamber of the housing, the inside being provided with furnishings and equipment suspended by the furnishings,

FIG. 7 is a schematic view of a possible and preferred embodiment of a garment according to the invention constituting an inner sleeve and an outer glove, and

FIG. 8 is a schematic view of a possible and preferred embodiment of a garment box according to the invention, preferably for containing a garment as described in FIG. 7

### DETAILED DESCRIPTION OF THE DRAWINGS

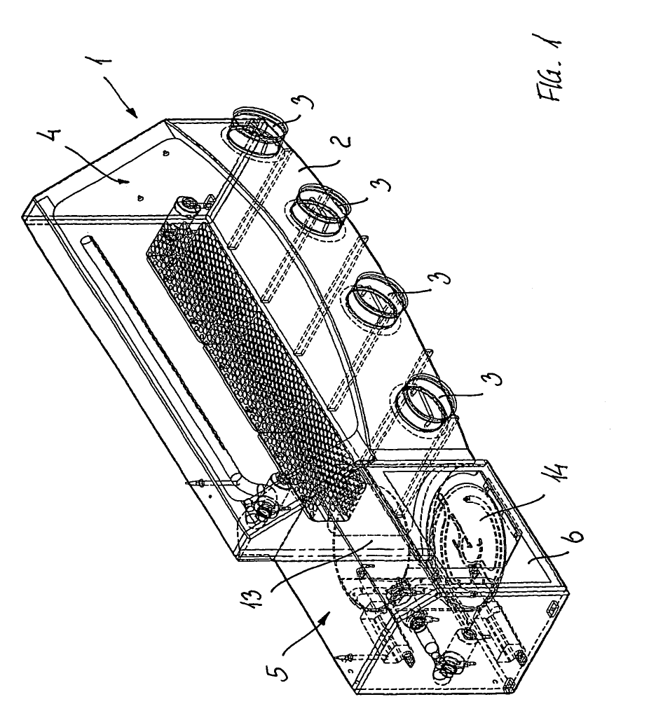

FIG. 1 is a schematic view of an embodiment of a workbench with a housing according to the invention. The workbench comprises the housing, which may be provided with either a single wall or a number of superimposed walls, preferably two walls. The workbench comprises a working chamber 1 divided from the adjacent surroundings by a number of walls. One front lower wall 2 is made of preferably stainless steel and is provided with four apertures 3. The apertures 3 are intended as passages for hands of one or two operators working with materials and devices in the working chamber 1. As will be explained later, the apertures 3 may comprise means for installing a garment such as gloves in the apertures, so that handling of the materials and devices in the working chamber during the operation taking place may take place anti-septic or even a-septic or even further sterile or may take place in consideration of other levels of non-contamination such as obtaining a third level of containment. Another front upper wall 4 is made of a transparent material such as glass and is slanted so that the one or two operators handling the materials and devices in the working chamber may view from above the handling taking place. Alternatively to making the front upper wall 4 of a transparent material, this wall may also be made of a non-transparent material. In order to view the handling taking place in the working chamber, cameras or the like visual recording means may be provided inside the working chamber and the recording may be displayed at a display means outside the workbench. The bottom and the back (not shown) of the workbench are preferably made of stainless steel.

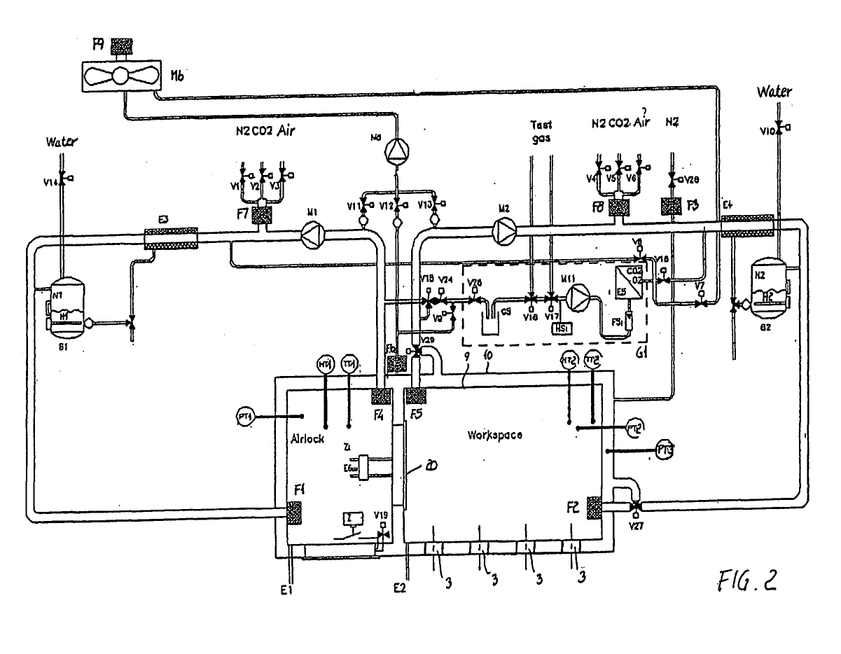

In a preferred embodiment of the workbench, the workbench comprises a housing comprising walls of the working chamber constituting walls of an inner space constituting a work space being the space containing a gaseous atmosphere. The working chamber walls are surrounded by intermediate chamber walls defining an intermediate chamber containing a gaseous atmosphere and substantially enclosing the working chamber (see FIG. 2). The working chamber walls and intermediate chamber walls define inner walls and outer walls of a continuous space being an intermediate space between the working chamber and the adjacent surrounding space. A possible way of controlling, adjusting and maintaining of a lower partial or total pressure in the intermediate chamber and a certain partial and total pressure in the working chamber and furthermore a certain humidity and temperature in the working chamber is shown in FIG. 2.

The gaseous atmosphere of the intermediate chamber comprises, in addition to the gas supplied, gas and airborne material percolated into the intermediate chamber from the adjacent surrounding space and is therefore preferably filtered for noxious material, for gases and for any contamination by a filtering system before the waste gas or airborne material is emitted to the environment. The filter is capable of filtering particles of a size down to 0.2 micrometer.

Beside the working chamber a transit means being an air lock 5 is provided. In the embodiment shown the transit means consists of a box which, as shown, are either integrated with the working chamber or which are separate from the working chamber. In the latter case, it will be possible to combine working chambers having different sizes and/or features with transit means such as the air lock also having different sizes and/or features. The air lock is preferably made of stainless steel and is provided with a hatch 6 in a front wall of the air lock. The hatch enables materials and devices to enter the air lock from the adjacent surrounding space. Within the air lock, further transit means, e.g. the kind of transit means shown in FIG. 3, are provided for transferring the materials and devices from the air lock to the working chamber and vice versa. The air lock may also be provided with either a single wall or a number of superimposed walls, preferably also two walls.

The hatch 6 is provided in the front wall of the air lock. The hatch, when closed, extends vertically and laterally to outer edges of the workbench. This results in the hatch, when closed, covering both an imaginary extension of the inner wall and the outer wall of the intermediate chamber forwards towards an inner surface of the hatch. Accordingly, the hatch is provided with two seas, an outer sealing placed on the inner surface (not shown) of hatch along a circumference corresponding to the imaginary extension outwardly of the outer wall of the intermediate space and an inner sealing also placed on the inner surface along a circumference corresponding to the imaginary extension outwardly of the inner wall of the intermediate space. When the hatch is closed, a distance between the inner sealing and the outer sealing is evacuated by providing passages from the intermediate space directed towards the front of the intermediate chamber and towards the part of the inner surface of the hatch extending between the inner sealing and the outer sealing. Thereby, when the hatch is closed, the distance between the inner sealing and the outer sealing becomes a part of the intermediate space.

As mentioned, the hatch has an inner surface (not shown), which preferably is substantially plane and the hatch, when opened, is preferably substantially horizontal. Thereby, the inner surface of the hatch, when the hatch is open, may serve as a small table for preparing materials and/or devices such as sterilising materials and/or devices before being transferred to the air lock. Because of the plane inner surface of the hatch, the materials and/or devices may be pushed gently from the hatch to the air lock without the need for lifting the materials and/or devices from the hatch to the air lock, which otherwise could cause the materials and/or devices such as substances in vitro to be tilted, stirred or in any other way unintentionally mishandled. Also, the possibility of gently pushing the material and/or devices from the inner surface of the open hatch to the air lock fulfils the demand of the operator handling the material and/or devices not being bend over the materials and/or devices after they have been sterilised or in other ways having been initially prepared. Finally, the hatch makes it more difficult and/or prevents an operator from unintentionally reaching into the air lock area with the risk of contaminating the air lock space with subjects, such as e.g. an arm, a sleeve or a glove, which might not be clean.

On top of the working chamber a control panel (not shown) may be provided. Alternatively, the control panel may be provided at any other suited position of the workbench such as at any of the walls of the working chamber or of the air lock. The control panel is optional and is intended for displaying the condition of the environment in the working chamber or the condition of materials enclosed in the working chamber. The condition of the materials may either be the temperature of the materials or of the environment, the partial pressure of different gasses such as oxygen or nitrogen in the immediate environment of the materials or still other conditions which is to be monitored in relation to a particular material and a particular process. On top of the working chamber a screen (not shown) may be provided under which lighting equipment is provided for providing light through the transparent front upper wall 4 to the work space within the working chamber.

The working chamber and the air lock constituting the major parts of the workbench may both be suspended on a casing (not shown) behind the working chamber and the air lock. The casing comprises at last means for elevating or lowering the working chamber and the air lock so that the height above the ground of the workbench may be adjusted. The casing may also and preferably comprise pumps, valves, tubing, piping, gas containers, measurement equipment, control and adjustment equipment and other devices to be used in connection with the materials and/or devices in the working chamber and the air lock or to be used in connection with the working chamber and the air lock themselves. The casing is preferably mounted on a wall or is placed on a floor, either placed directly on the floor or supported by leggings. Alternatively to suspending the working chamber and the air lock on the casing, the working chamber and the air lock may themselves be suspended directly on a wall or may be placed on a number of leggings supporting the chamber and the lock.

FIG. 2 is a diagram showing in principal how the partial and the total gas pressure of selected gas species are obtained in the working chamber, the air lock and the intermediate chamber, how adjustment of the temperature of at least the working chamber but preferably also the air lock is obtained and how the humidity of the atmosphere in at least the working chamber, but preferably also in the air lock is controlled, adjusted and maintained.

The workbench is shown comprising the working chamber constituting a work space, the air lock and the intermediate chamber constituting the intermediate space between inner walls 9 and outer walls 10 of the intermediate chamber. The four apertures 3 for inserting gloves for the operator(s) operating in the working chamber are shown in the front of the workbench. Conduits such as pipes and/or tubes for supplying and removing of selected gas species are shown. Conduits are leading to and from the working chamber, conduits are leading to and from the air lock and conduits are leading to and from the intermediate chamber. The conduits for the air lock and for the working chamber are each provided with a circulation pump M1 and M2, respectively, and with an inlet for supplying the selected gases to the conduits.

In the embodiment shown the inlet of the air lock and the inlet of the working chamber each are provided with three valves V1,V2,V3 and V4,V5,V6, respectively, for adjusting the supply of three different selected gasses. Preferably the selected gases are nitrogen, N₂, carbon dioxide, CO₂, and clean atmospheric air. In other embodiments of the apparatus according to the invention other gases may be selected for a specific operation on specific materials. In the embodiment shown, the conduits for the intermediate space is provided with a single valve for adjusting supply of nitrogen, N₂, to the intermediate space. Nitrogen is selected in order to displace any oxygen present in the intermediate chamber. Another gas than nitrogen may be selected for a specific purpose or for displace or react with even other gases present in the intermediate chamber.

A vacuum pump M5 is provided for evacuating the working chamber, the air lock and the intermediate chamber. A displacement pump M6 is provided for expelling the evacuated gases from the vacuum pump M5. The vacuum pump M5 is connected through valves V11,V13 to the conduits of the air lock and of working chamber and is also connected through a valve V12 to the intermediate chamber. The vacuum pump M5 is the pump regulating the total gas pressure in the working chamber, in the air lock and in the intermediate space.

Filters F1,F2,F3,F4,F5,F6 are provided wherever gas is let to the air lock, the working chamber and the intermediate space and filters F4,F5,F6 are also provided wherever gas is being let out of the air lock, of the working chamber and the intermediate space. Supplementary filters F7,F8 are provided between the valves for letting the selected gases into the conduits of the air lock and the working chamber, respectively, and the conduits themselves. A filter F9 are also provided between the displacement pump M6 and the surrounding space adjacent the workbench. The filters are preferably filters being capable of filtering particles having a size as small as 0.2 micrometer, preferably filters known as HEPA filters from Honeywell.

Each of the conduits is provided with outlets leading to a gas analyser G1. The gas analyser is shown with dotted lines around the components forming part of the gas analyser. The outlets are connected through valves V15,V24,V9 to a main conduit through the gas analyser. The valves are to be mutually adjusted in order for the gases from the outlets being representative of the gases in the working chamber, in the intermediate chamber and in the air lock. Inside the gas analyser, a valve V26 is provided for shutting off the connection between the outlets and the analyser in case one or more of the gases from the outlets are too humid. The gas analyser does not tolerate too humid gases. A humidity guard G5 is therefore provided in the analyser. The gas analyser is provided with two inlets for supply of test gases for testing the analyser. The inlets are connected through valves V16,V17 to the main conduit in the analyser. Preferred gases utilised as test gases are oxygen, O₂ , and carbon dioxide, CO₂. A circulation pump M11 is provided in the analyser for pumping the gases from the outlets through the analyser.

The conduit of the working chamber and the conduit of the air lock are each provided with supply lines from means for supplying vapour to the conduits and thus to the chambers for adjusting the humidity of the atmosphere in the working chamber and in the air lock. The means consist of small vessels B1,B2 having an inlet for supplying liquid, preferably water, more preferably ion exchanged water. The inlets are connected through valves V10,V14 to the vessels: The vessels are each also provided with a heating element H1,H2 for heating the liquid inside the vessel, and a level sensor N1,N2 for sensing the level of liquid inside the vessel. Furthermore the vessels are provided with an outlet for expelling any possible surplus water from the vessels or just for the possibility of emptying the vessels.

The conduit of the air lock and the conduit of the working chamber are each also provided with cooling elements E3,E4 surrounding the conduits for aiding in adjusting the temperature of the atmosphere in the working chamber and in the air lock. The cooling elements are preferably cooled by means of a Peltier element, but may be cooled in any other suitable way such as by frozen carbon dioxide or liquid nitrogen. As shown, the cooling elements are also provided with outlets for the possibility of emptying surfaces of the cooling elements, being Peltier elements, of humidity in the surrounding space condensing as dew on the elements.

The air lock and the working chamber are each provided with a temperature sensor TT, a pressure sensor PT and a humidity sensor HT. The sensors control the gaseous atmosphere of the air lock and of the working chamber. The sensors transmit signals to a central control unit (not shown) preferably comprising a computer unit and a PLC. The control unit is capable of adjusting the inlet of the different selected gases, is capable of adjusting the amount of humidity formed in the vessels and the cooling rate and the total cooling of the cooling elements. The intermediate chamber is only provided with a pressure sensor PT for controlling the pressure in the intermediate chamber. The control unit is also capable of adjusting the pressure of the selected gas in the intermediate chamber.

The walls of air lock and the working chamber, i.e. the inner walls of the intermediate space are preferably heated in order to avoid formation of dew on the surfaces of the inner walls. The heating is preferably provided by means of heating foil with electrical resistance wiring heated by supplying electrical power E1,E2 to the wiring. The heating foil is provided at the outer surfaces of the walls, which are the surfaces directed towards the intermediate chamber. The heating is adjusted in respect of the controlling and adjusting of the temperature, the pressure and the humidity of the gaseous atmosphere within the air lock and within the working chamber.

Alternative to, or in addition to, heating of the inner walls by means a heating foil, the intermediate space may contain an amount of heat transmitting fluid, either a gas or a liquid. The fluid may be capable of transferring heat from the fluid to the inner walls and thereby to the gaseous atmosphere and any materials and equipment in the working chamber. Thereby, any dew may be avoided, and if necessary, heating of the gaseous atmosphere in the working chamber may be accomplished. Alternatively, the fluid may be capable of accumulating heat from the inner walls and thus from the gaseous atmosphere and any materials and equipment in the working chamber. Thereby, the working chamber may be cooled down, if necessary. Depending on the need for transferring heat to the inner walls or accumulating heat from the inner walls, both the type of fluid, i.e. a gas or a liquid, and the amount of fluid may be selected and adjusted to the actual need.

Between the air lock and the working chamber transit means 19 are provided. Preferably, the transit means is a carrousel as shown in FIG. 3. An activator Z1 is provided for operating the transit means such as establishing an initial linear displacement and a subsequent angular displacement of the carousel as described with reference to FIG. 3. The activator is preferably electrically powered by supplying electrical power E6. Between the air lock and the outside of the workbench in connection with the hatch a sensor Z2 is provided for controlling whether the hatch is properly closed or not. If the hatch is not properly closed the activator cannot operate the transit means. Thereby it is assured that the gaseous atmosphere of the air lock and subsequently the gaseous atmosphere of the working chamber is not unintentionally contaminated with any contaminants from the surrounding space of the workbench. Finally, a valve V19 is provided between the intermediate chamber and the space between the inner sealing and the outer sealing on the inner surface of the hatch as described with reference to FIG. 1. When the hatch is properly closed, the valve is opened and the space between the inner sealing and the outer sealing then constitutes part of the intermediate chamber.

FIG. 3 is a plane view of the workbench with the housing according to the invention, and being illustrated with an embodiment of a transit means for transferring material and/or devices from a surrounding space such as the air lock adjacent the working chamber and to the working chamber. In the embodiment shown, the transit means is a kind of carrousel having an open side 11, in the situation shown turned towards the first chamber, and a closed side 12 opposite the closed side. The open side 11 extends over a larger angular distance a than an angular distance β of closed side 12. In the schematic view, the open side is directed towards the left. The carrousel has a top plate 13 (see FIG. 1) and a bottom plate 14 (see FIG. 1).The bottom plate 14 is provided with tenons 15 protruding upwards and downwards, respectively. Alternatively, only the top plate 13 is or both the bottom plate 14 and the top plate 13 are provided with the tenons. The tenons protrude into grooves 18 provided in a guide plate (not shown) provided beneath the bottom plate 14 of the carrousel. Alternatively, a guide plate is provided only above or both beneath and below the carrousel. The carrousel is intended for being placed between an adjacent surrounding space such as the air lock and the working chamber. The carrousel may be used in workbenches having a working chamber with either a singe wall or a number of superimposed walls.

Initially, the open side of the transit means constituted by the carrousel is directed to the left towards the air lock being a space adjacent the working chamber. Materials and/or devices, which are situated in the air lock, are placed in the carrousel. Thereafter, the carrousel is initially pushed in the left direction, i.e. in the direction of the air lock away from the working chamber. The initial displacement to the left causes the tenons to follow the first part of the grooves. This only causes a mainly linear displacement. When the carrousel subsequently is pushed further to the left, the displacement becomes a combined rotation of the carrousel and displacement to the left towards the working chamber. When the carrousel finally is pushed further to the right, the carrousel will have performed a rotation of some degrees up to perhaps 1800 and the open side will be directed to the right towards the working chamber. The materials and/or devices placed in the carrousel may then be retracted from the carrousel into the working chamber.

By providing the carrousel with the tenons and by letting the tenons follow the grooves as shown and described, several advantages are obtained. Firstly, the space available in the carrousel is precisely defined and this space is available during the entire transfer of the materials and/or items from the surrounding space such as the air lock adjacent the working chamber and to the working chamber. Secondly, rotation of the materials and/or devices is a very gentle way of displacing the materials and/or devices compared to a manual placing and removal of the materials and/or devices from the adjacent surrounding space to the working chamber through doors in an outer wall and in an inner wall of intermediate space. Thirdly, by initially displacing the carrousel to the left towards the air lock before starting the rotation of the carrousel, it is assured that the closed side of the air lock, before transfer of the materials and/or items from the air lock to the working chamber, is displaced away from abutment with sealing provided along an inlet to the working chamber. Thereby, the sealing is not worn. Finally, because the carrousel only has to be pushed and the correct displacement being a combined linear and rotational displacement takes place automatically because of the tenons and the guide plates, there is no risk of the transit means being wrongly operated. The safety towards correct handling of the material and/or devices in the transit means constituted by the carrousel is therefore ensured.

The carrousel may be provided with a number shelves or holders with the purpose of increasing the area for placing materials and/or devices within the carrousel. Thereby, the amount of materials and/or devices, which may be transferred from the air lock to the working chamber during a single transfer may be increased accordingly. Also, by providing the carrousel with a larger area for placing the materials and/or devices, the carrousel itself may function as an interim chamber for containing materials and/or devices between the air lock and the working chamber.

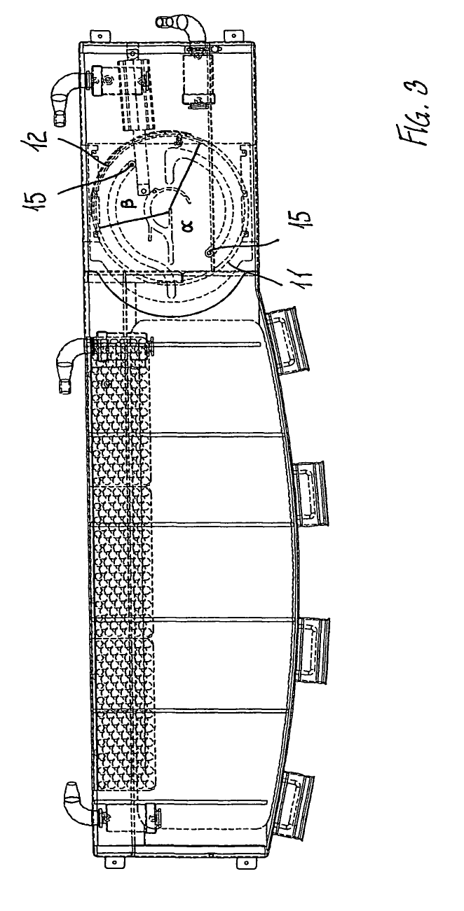

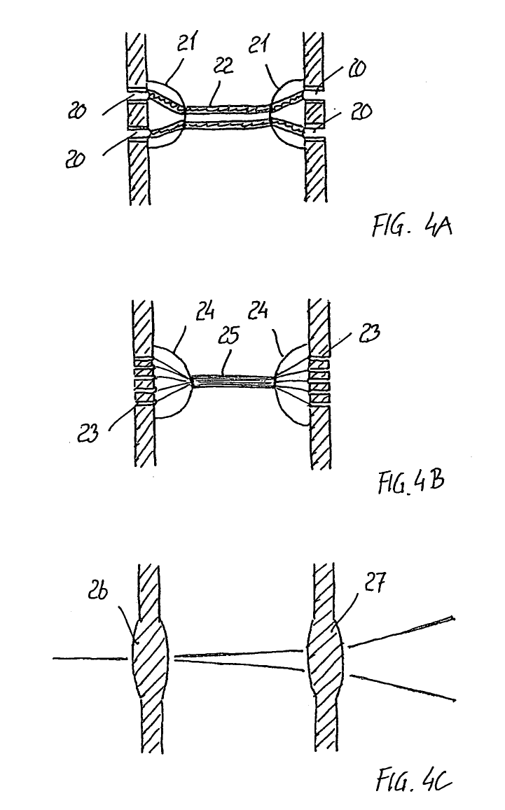

FIG. 4A-4C schematically show different other transit means for transferring different media from adjacent surrounding space to the working chamber through at least two superimposed walls of the workbench. The transit means comprise cords for transferring electrical power, tubes or pipes for transferring fluids such as specific gasses or selected liquids, cables for transferring data such as video signals, sensor signals or data to and/or from computer equipment within and/or outside the working chamber or any other media needed for performing a specific process within the working chamber.

FIG. 4A shows a transit means for transferring electrical power to and/or from the working chamber. Female slots 20, as shown, for male pins, alternatively male pins for female slots, are provided in the wall of the working chamber constituting an inner wall of an intermediate space, and in the outer wall of the intermediate space. The female slots are of course made of metal and a front side of the slots directed towards the adjacent surrounding space and the working chamber, respectively. Inside the intermediate space the rear side of the slots are encapsulated. Between each of the encapsulations 21 an electrical cord 22 extends in order to transfer the electrical power between the slots in the inner wall and the slots in the outer wall of the intermediate space. Any substances or gasses in the adjacent surrounding space or within the working chamber will not be able to migrate through the intermediate space. Migration cannot take place in the metallic female slots. However, any leakage between the female slots and the walls may cause substances or gasses to migrate from the surrounding space or from the working chamber towards the intermediate space. However, the encapsulation prevents any such migration from entering the intermediate space. Migration, which could have taken place along the insulation of the cord or within the cord itself if the cord was just passed through both walls, is thus prevented.

FIG. 4B shows a transit means for transferring signals of any kind to and/or from the working chamber. The signals may be from temperature sensors, from pressure transducers, from humidity sensors, from any light sensors etc. Female plugs 23, as shown, for male pins are provided in the wall of the working chamber constituting an inner wall of an intermediate space, and in the outer wall of the intermediate space. The female plugs are made of metal and plastic or ceramics. Inside the intermediate space the plugs are encapsulated. Between each of the encapsulations 24 a cable extends in order to transfer the signals between the plugs in the inner wall and the plugs in the outer wall of the intermediate space. Any substances or gasses in the adjacent surrounding space or within the working chamber will not be able to migrate through the intermediate space. Migration cannot take place in the metallic female plugs. However, any leakage between the plugs and the walls or the plastic parts of the plugs may cause substances or gasses to migrate from the surrounding space or from the working chamber towards the intermediate space. However, the encapsulation prevents any migration from entering the intermediate space. Migration which could have taken place along the insulation of the cable or within the cable itself if the cable was just passed trough both walls, is thus prevented.

FIG. 4C shows a transit means for enabling visual transfer of data between the adjacent surrounding space and the working chamber. The transit means may of course just be a window made of glass or any other transparent material impermeable to any migration of substances and gasses. However, in order to enhance the possibility of transferring visual data, e.g, viewing data on a display of a device within the working chamber to a person in the adjacent surrounding space using only the eyes to visually read the display, the transfer means for transferring visual data may comprise lenses 26,27 or other light transporting devices, as shown, which magnifies the data of e.g. the display. Thereby, the reading of the data becomes easier without the need for handling the device in order to read the data.

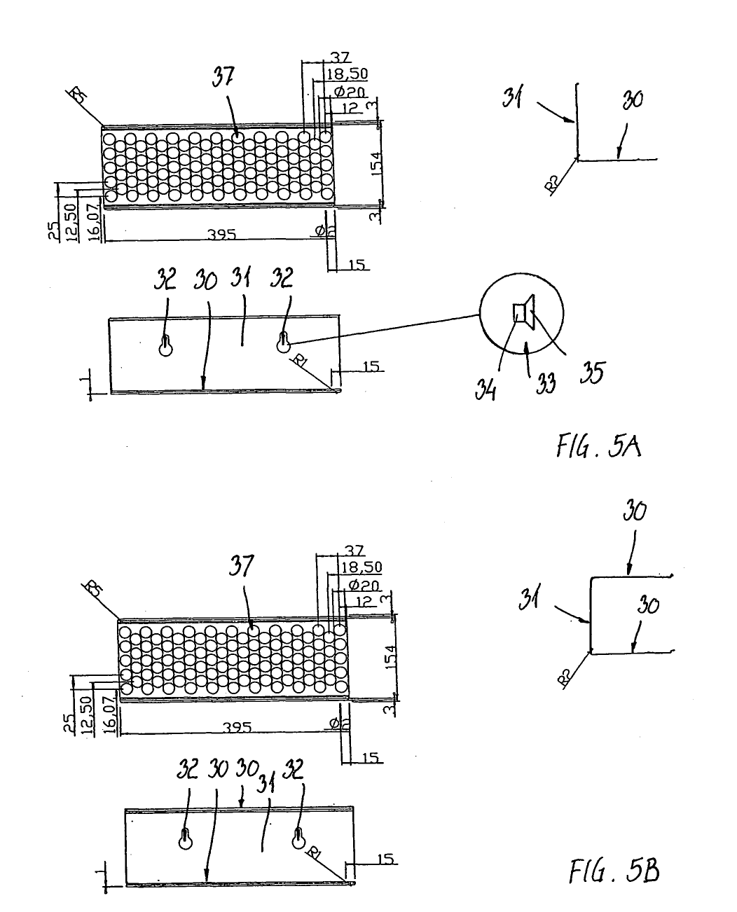

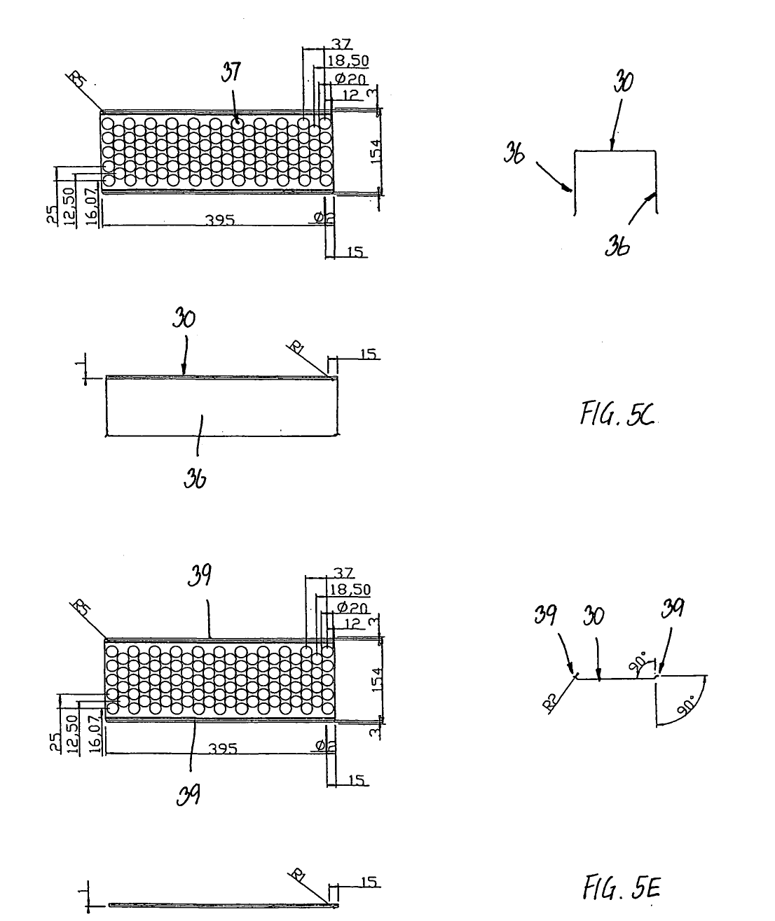

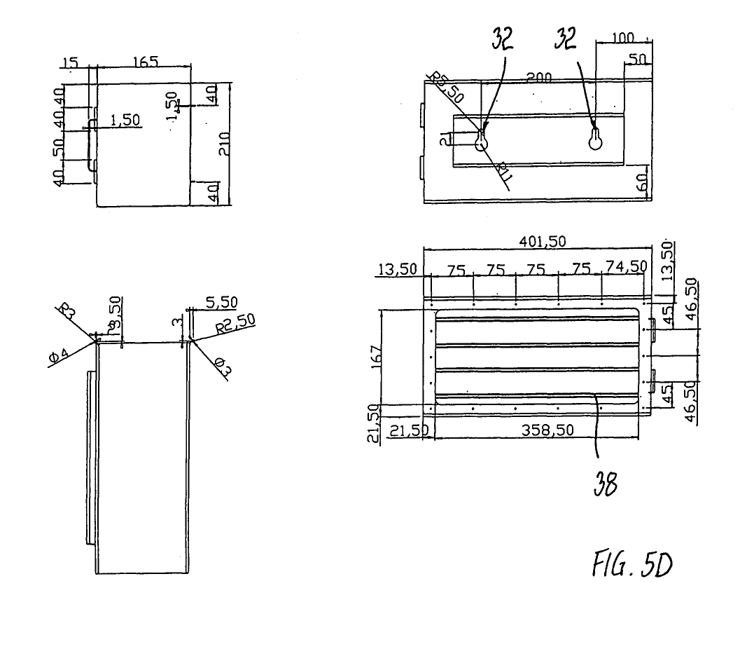

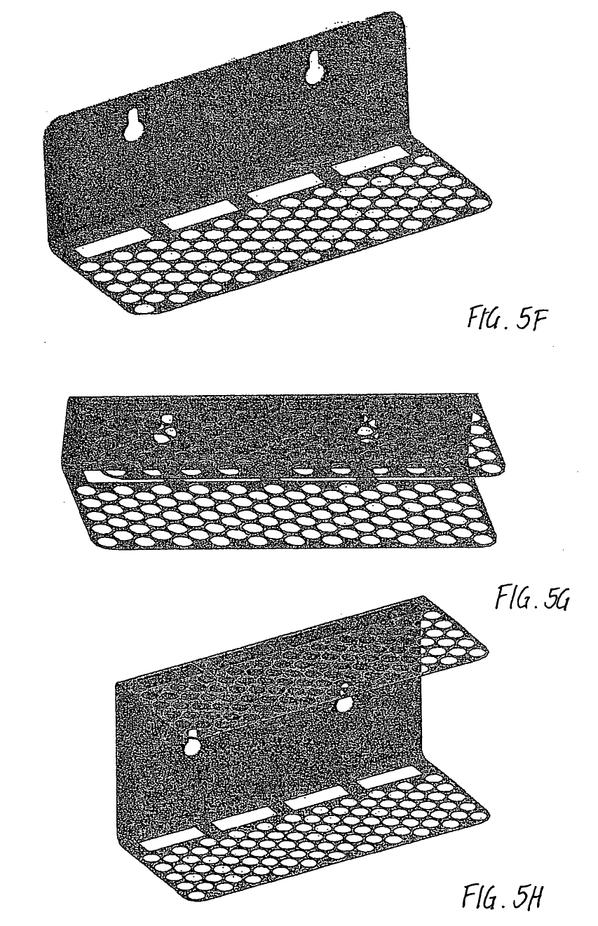

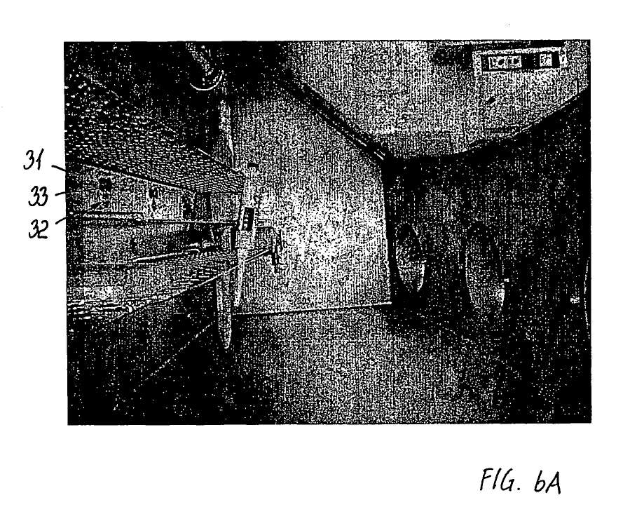

FIG. 5A-5H show possible furnishings intended for being provided inside the housing and for bearing, for use in handling and for use, when treating of materials inside the housing. The furnishings are preferably made of stainless steel, possible being plated. It must be noticed that the dimensions on the figures only are examples of possible and preferred dimensions. However, other dimensions and other embodiments than the ones shown may be provided for fulfilling different needs and for use in housings of different size and/of different lay-out of the interior walls, piping etc. Also, other materials than stainless steel, as example aluminium or plastic may be used for manufacturing the furnishings.

FIG. 5A and FIG. 5B are possible embodiments of plates shaped into shelves to be suspended along inner walls of the housing. One or two bearing surfaces 30 and a suspension surface 31 constitute the shelves. The suspension surface is made by bending the plate, which the shelf is made of. The suspension surface is provided with substantially key-hole shaped holes 32 with the circular part of the key-hole shape pointing downwards and the oblong apart of the key-hole shape pointing upwards. In the embodiments shown, only two holes are shown. However, more holes may be provided.

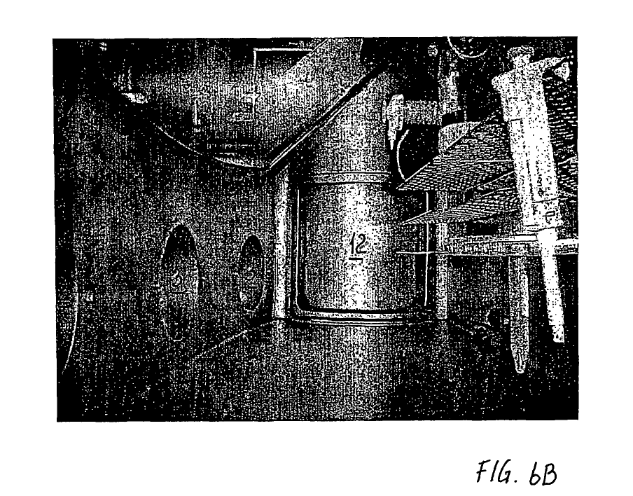

The key-hole shaped holes are intended for co-operating with corresponding substantially T-shaped suspension means 33, shown in detailed figure (see also FIG. 6A), intendedf for extending from the inner walls of the housing. The T-shaped suspension means exhibit a stem 34 of the T-shape and a top bar 35 of the T-shape. The stem of the T-shaped suspension means may have a length corresponding to a thickness of the plate, which the shelves are made of. Alternatively, the stem of the T-shaped suspension means have a length corresponding to two, three or more times the thickness of the plate, which the shelves are made of. Thereby, more differently configured shelves may be suspended on the same number of T-shaped suspensions means (see FIG. 6A and FIG. 6B).

The shelves are attached to the inner walls by initially displacing the circular part of the key-hole shaped holes in the suspension surface laterally past the top bar of the T-shaped suspension means extending from the inner wall of the housing. Subsequently, when the suspension surface of the shelf is past the top bar of the T-shaped suspension means, the shelf is displaced downwards so that the shelf is supported by the stem of the T-shaped suspension means at the upmost part of the oblong part of the by key-hole shaped holes in the suspension surface.

FIG. 5C shows, alternatively to a suspension surface extending upward from the bearing surface 30, supporting leggings 36 may be provided extending downward from the bearing surface. The supporting leggings may still be made by bending outer edges of the plate, however, bending the edges of the plate downwards. The leggings may have a lateral extension along the entire length of the plate, or the leggings may have an extension limited to the outer ends of the plate. By providing leggings, the plate actually is shaped into a small table capable of being placed at an inner surface of a bottom of the housing.

The bearing surface 30, irrespective of whether the plate constitutes a shelf or a small table, is preferably provided with holes 37 evenly spaced in the bearing surface. The holes are made for two reasons. Primarily, the holes may constitute holding means for pipettes, test tubes and the like being inserted into the holes (see FIG. 6A and FIG. 6B). Thereby, no additional specially designed means are needed for holding these items. The holes may have the same universal diameter or may have different diameters. Holes having the same diameter are dimensioned so that as many different items as possible may be inserted into and may be held by the bearing surface of the shelf or the table. Holes of different diameter may be dimensioned for different items, as example some holes for pipettes, other holes for test tubes and still other holes for pulling cords, hoses and the like through the holes and further on to test equipment placed on the bearing surface of the shelf or the table.

The holes of the shelves or the tables may not only serve for holding different items, but may also serve as a means for pulling along the bearing surface items placed on the bearing surface. By means of the pulp of a finger, it is possible through the holes to manually handle any item placed on the bearing surface. By obtaining frictional contact between the pulp of a finger and an underside of an item to be handled, it is possible to drag the item along the bearing surface by succesively obtaining frictional contact between the pulp of the finger and the underside of the item along a line of holes, as example from holes near the rear side of the supporting surface to the front side of the bearing surface. Thereby, it is possible to drag an item from the rear side to the front side of the bearing surface only by touching the underside of the item. The item may be a holder for test tubes, may be any test apparatus, may be a Petri dish or may any other item used in the housing and supported by the bearing surface of a shelf or a table within the housing.

Preferably, the holes of the shelves or the table are chamfered, at least on the underside of the bearing surface. Thereby, no sharp edges are present, when dragging items along the bearing surface in the manner described above. The elimination of sharp edges presents two advantages. Firstly, the ease by which the pulp of the finger is pulled from one hole to another hole along the line of holes is enhanced. Secondly, when using gloves, the risk of the gloves being torn is eliminated, which on the other hand could lead to contamination of the environment inside the housing.

FIG. 5D shows, additionally to providing shelves and tables, a casing functioning as incubator may be provided inside the housing. The incubator may be intended for suspension along inner side walls of the housing in the same manner as the shelves are suspended, i.e. with key-hole shaped holes 32 provided in a rear surface of the incubator and intended for co-operating with T-shaped suspension means (see FIG. 5A) extending from the inner walls. Alternatively, the incubators may be intended for being placed on the inside bottom of the housing. In the firstly mentioned case, where the incubator is suspended along inner walls of the housing, the incubator is preferably provided with a door in one or more of the vertical surfaces of the incubator, said door preferably being provided with a window for monitoring the content of the incubator. In the latter case, where the incubator is placed on the bottom of the housing, the incubator is preferably provided with a lid in the top surface of the incubator, said lid also preferably being provided with a window for monitoring the content of the incubator.

FIG. 5E shows a shelf to be used in an incubator as the shelves described in relation to FIG. 5A and FIG. 5B. In the embodiment shown, the shelf is provided with a bearing surface identical to the bearing surfaces of the shelves shown in FIG. 5A and FIG. 5B. Different to the shelves shown in the previous figures, the shelf is not provided with a suspension surface but is provided with edges 39 intended for being suspended in railings 38 (see FIG. 5D) provided along inner side walls of the incubator. In the embodiment shown, the edges are bent slightly upwards in order to visually indicate a top side and a bottom side of the shelf, the top side being the one in the direction of which the side edges are bent. Also, as is the case with the shelves shown in FIG. 5A and FIG. 5B, the shelf is provided with holes for the same reason as mentioned in relation to FIG. 5A and FIG. 5B and the holes are preferably also chamfered for the same reasons as mentioned in relation to FIG. 5A and FIG. 5B.

FIGS. 5F, 5G and FIG. 5H are perspective views of possible slightly different embodiments of the shelves according to the invention. The difference in relation to FIG. 5A and FIG. 5B is the addition of rectangular holes at the inner part of the shelves. Apart from this difference, the features mentioned and described in relation to FIG. 5A and FIG. 5B are the same, and the description of FIG. 5A and FIG. % B are hereby incorporated by reference.

FIG. 6A and FIG. 6B are photographs taken from inside an embodiment of the housing, inside the first chamber. FIG. 6A shows the inside of the first chamber seen from the air lock. FIG. 6B shows the inside of the first chamber seen from the opposite side of where the air lock is situated in the first chamber, thus seen in direction of the air lock. The air lock is shown in a closed state. Shelves suspended on the suspension means are shown, and a test tube and a pipette are shown suspended through the holes in the bearing surface of the shelves. Petri dishes are shown supported on the bearing surface.

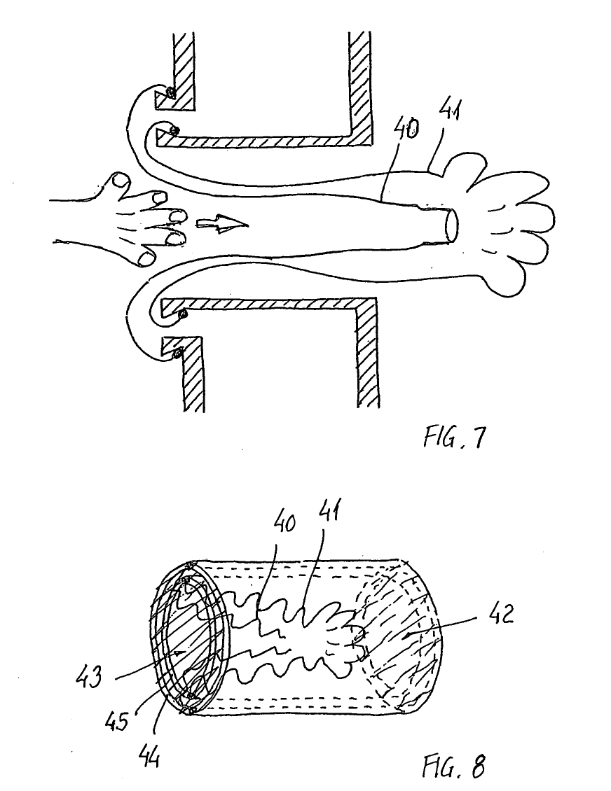

FIG. 7 shows schematically a garment to be used when handling materials and/or devices in the working chamber of the apparatus according to the invention or when handling materials and/or devices in any other apparatus where a demand for an anti-septic or even an a-septic or even further a sterile environment or other levels of in other way non-contamination of a working chamber is needed. In the embodiment shown, the garment consists of an inner flexible layer shaped like a sleeve 40 and an outer flexible layer shaped like a glove 41 and vice versa in order for an operator handling the materials and/or devices during the operation in the working chamber to use the fingers as well as the hands when handling the materials and/or devices.

The one end of the outer glove is attached to the inner wall of the intermediate space and the other end of the outer glove with the fingers extends into the working chamber. The one end of the inner sleeve is attached to the outer wall of the intermediate space and the other end of the sleeve of the inner sleeve extends into the workspace. When a hand and forearm of an operator to handle materials and/or devices during the operation within the working chamber is stretched into the inner sleeve, an outer surface of the inner sleeve is in contact with an inner surface of the outer glove. The other end of the inner sleeve is preferably provided with a cuff for ensuring a tight contact between the inner sleeve and the skin of the wrist or forearm of the operator. The other end of the outer glove with the fingers need not fit tight around the fingers and hand of the operator. However, for ensuring a proper contact through the outer glove between the hand and fingers of the operator and the materials and/or devices to be handled during the operation, a tight fit is nevertheless preferably established.

The gloves are preferably made of a resilient material in order to ensure a tight contact along the entire circumference of the gloves. The outer glove is preferably made of silicone or latex rubber and the inner sleeve is preferably made of latex rubber. Also, the inner sleeve have dimensions at least at the cuffs and preferably also along a part of the remainder of the glove being under-sized in comparison with the circumference of at least the wrists and preferably also the forearm of the operator. Thereby, the cuffs of the inner sleeve will be resiliently stretched when the cuffs fit tightly around the wrist of the operator and the glove preferably also fits tightly around the forearm of the operator. The space established between the outer surface of the inner sleeve and the inner surface of the outer glove becomes part of the intermediate space. During the entire operation being performed in the working chamber, the part of the operator's hand and forearm extending from the cuffs of the inner sleeve will be subjected to the low pressure in the intermediate space and thus be subjected to the evacuation of any contamination in the intermediate space taking place during the entire operation.

The garment consisting of the outer glove and the inner sleeve is especially advantageous when inserting the gloves into the apparatus with the working chamber and when replacing the gloves with a new set of gloves. An outer surface of the outer glove with the fingers is the only parts of the garment being in contact with the environment of the working chamber. More important, the inner surface of the inner sleeve is the only part of the garment being in contact with the environment of the adjacent outer space when the hand and forearm of the operator is inserted into the sleeve and the glove. If the outer glove with the fingers is punctured, any contamination from the workspace will be led to the intermediate space. Thus, contamination from the adjacent outer space to the working chamber and any substances or gasses from the working chamber escaping from the working chamber to the adjacent surrounding space is impossible.

If the contact between the outer surface of the inner sleeve and the inner surface of the outer glove is unintentionally not preserved during the process in the working chamber, then the space established may cause substances and gasses to enter the space. However, due to the fact that the outer glove is attached to the inner wall of the intermediate space and the inner sleeve is attached to the outer wall of the intermediate space, then the low total pressure in the intermediate space will cause any substances and gasses to be trapped in the intermediate space and being led out through the gas outlets of the intermediate space.

The constructional principle of the garment ensures a very high degree of close and non-permeable contact between the inner sleeve and the outer glove, and thus ensures a very little risk of contamination migrating between the adjacent outer space and the working chamber. However, if the constructional principle is not enough to ensure the degree of non-contamination, then the physical principle of the apparatus, i.e. the intermediate chamber according to the invention, will ensure that the disadvantages, which may occur in relation to the garment is remedied by the apparatus.

FIG. 8 shows schematically a garment box to be used in any apparatus where contamination of an environment in a working chamber is to be avoided. Thus, the garment box may be used in combination with the apparatus according to the invention but may also be used in combination with other apparatuses not forming part of the invention. The garment unit to be described is however especially advantageous in combination with the apparatus according to the invention because the garment box containing a garment functioning the same way as described above can ensure that not only an anti-septic but even an a-septic or even further a sterile environment may be obtained within the working chamber. Also, the garment box according to the invention together with the apparatus according to the invention can ensure that a third level of containment as defined in the space industry may be obtained.

The garment box consists of a cylindrical casing having means for attaching the garment box in a sealing manner to the apparatus with the working chamber. The means may be any kind of means ensuring the sealing attachment, but preferably the means consists of a kind of bayonet joint or of a screw thread. The box has an inner cover 42 and an outer cover 43. In the embodiment shown, the covers are constituted by foils being secured to edges of the casing. Furthermore, the cylindrical casing is divided into an outer casing 44 and an inner casing 45 corresponding to the outer wall and the inner wall of the intermediate space of an apparatus with two superimposed walls. The outer casing and the inner casing is provided with sealing intended for establishing a sealing engagement between the outer casing and the inner casing and a corresponding outer wall and inner wall, respectively, of an intermediate space of an apparatus. Inside the garment box between the outer foil and the inner foil an inner sleeve 40 and an outer glove 41 is contained. Unlike the garment described in FIG. 7, the inner sleeve of the garment box only constitutes a diaphragm with a narrow small hole, and does not constitute an actual elongated glove extending along the forearm of the operator introducing the hand to handle the material and/or devices. However, the narrow small hole of the inner sleeve serves the same purpose as the cuffs of the inner sleeve described in FIG. 7, namely establishing a tight fit, not around the wrist, but around the forearm or perhaps the upper arm of the operator. The outer glove with the fingers is similar to the one described in FIG. 7.

When gloves are to be installed in the walls of an apparatus, the casing is placed in the apertures (see FIG. 1) so that the sealing mentioned above is established. Thereafter, the outer foil constituting the outer cover is removed from the inner casing establishing access to the inner sleeve and the outer glove in the casing. The inner sleeve constituting only a diaphragm is penetrated by the hand of the operator. If possible, the operator finds the outer glove and puts at least the fingers of the hand into the fingers of the glove. Thereafter, the inner foil constituting the inner cover is penetrated and the hand and forearm in the outer glove with the fingers are pushed forwards into the working chamber. By inserting the gloves like described, and by firstly removing the inner foil, subsequently passing the hand and the forearm through the inner sleeve, thereafter placing the hand and fingers in the outer glove and finally penetrating the inner foil, a complete safe way is obtained of enabling the operator to gain access to the working chamber without the risk of contamination entering the working chamber.

In addition, in the walls covering the lid, opposite to this lid, a double walled sealing mechanism can be provided in such way that a double walled sealing will be out of function when the lid is removed after the inserted gloves are in place, whereas the double walled system will be in function when a pair of gloves are being mounted or removed. Such a mechanism may be in the form of a switch system activating the double walled function when the lid is in place or being placed and thereby ensuring that contaminants do not enter the workspace. A mechanism can be that a switch or similar means is activated when the lid is close to the aperture where it is to be inserted.

In a preferred embodiment, the inner wall of the intermediate space is provided with a lid sealing up the working chamber from the intermediate space and from the adjacent surrounding space through the apertures. This results in that after the inner foil mentioned above has been penetrated, the lid has to be removed and placed inside the working chamber before the operator has access to the working chamber. However, providing a lid being capable of closing the apertures along the inner wall of the intermediate space has a great advantage. When the gloves already inserted in the apparatus are to be removed or substituted, the reverse installation mentioned in the above paragraph is performed. If there is no possibility of sealing up the working chamber from the intermediate space and from the adjacent surrounding space when pulling the hand of the operator backwards in order to draw out the hand of the outer glove and the inner sleeve, there is a severe risk of the outer glove being damaged and punctured resulting in contamination of the working chamber. If care is taken when drawing the hand and forearm out of the outer glove and the inner sleeve, contamination may well be avoided. However, by sealing up the working chamber from the intermediate space and from the adjacent surrounding space, the risk is eliminated independent on whether the outer glove is damaged or not during drawing out of the hand of the operator. Also, substitution of the gloves with a new set of gloves is not possible if the lid is not provided sealing up of the working chamber.

As mentioned above, both the garment itself being the combination of the inner sleeve and the outer glove as described in FIG. 5 and the garment box as described in FIG. 6 may be used in combination with the apparatus according to the invention as described in FIG. 1-4 or may be used in combination with other apparatuses not forming part of the apparatus according to the invention. However, the advantages of the apparatus according to the invention is enhances if the garment and the garment box is used in combination with the apparatus. However, the performance of other apparatuses may also be improved in relation to the insertion and drawing back of the hand and forearm of the operator if the garment and/or the garment box according to the present invention is used in apparatuses not forming part of the invention.

1. A method for performing, at a particular partial pressure of a selected gas species in a gaseous atmosphere or at a particular total gas pressure of a gaseous atmosphere, an operation in a housing, said housing comprising first chamber walls defining a first chamber containing a gaseous atmosphere, and said operation being performed in the said first chamber while
a) the partial pressure of the selected gas species of the first chamber is lower than the partial pressure of the selected gas species in the gaseous atmosphere in the adjacent surrounding space, or the total gas pressure in the atmosphere of the first chamber is lower than the total gas pressure in the gaseous atmosphere in the adjacent surrounding space, and
b) materials and/or devices for carrying out the operation is carried through to the first chamber from the adjacent surrounding space through the first chamber wall along transit means in the first chamber walls in such a way that no gas from at least the adjacent surrounding space is capable of migrating from the adjacent surrounding space through the transit means in the first chamber walls to the first chamber
c) the carrying through taking place through an air lock, said air lock being provided with a carrousel for transferring material and/or devices into the first chamber, said carrousel being angularly displaced during rotation from a first angular position where materials and/or devices are placed in the carrousel to a second angular position where the materials and/or devices are removed from the carrousel and placed in the first chamber,
d) and where a closed side of the carrousel, when the first chamber is sealed off from the air lock, is in abutment with seals along an entrance to the first chamber, and where the carrousel, when entrance to the first chamber is to be established, initially is linearly displaced away from the abutment with the seals, and subsequently is angularly displaced during rotation from the second angular position to the first angular position.

2. A method according to claim 1, wherein the operation is performed in the first chamber on a material that is being transferred by means of the transit means from the adjacent surrounding space to the first chamber, and that the material is a non-gaseous material.

3. A method according to claim 1, wherein the operation is performed in the first chamber on a material that is being transferred by means of the transit means from the adjacent surrounding space to the first chamber, and that the material is a gaseous material.

4. A method according to claim 1, wherein the gaseous atmosphere of the adjacent surrounding space is air of the ambient atmosphere.

5. A method according to claim 1, wherein the operation is performed at a particular partial pressure of a selected gas species in the atmosphere of the first chamber, the ratio between the partial pressure of the selected gas species in the second chamber and the partial pressure of the selected gas species in the first and in the adjacent surrounding space chamber being at the most 1.00, e.g. at the most 0.99 such as at the most 0.97, e.g. at the most 0.95 such as at the most 0.90.

6. A method according to claim 5, wherein a number of gases are supplied to the first chamber, the composition of gases supplied being adapted to provide the particular pressure in the first chamber, and the gases supplied to the first chamber being carried through to the first chamber through transit means, a part of said transit means being in contact with the first chamber wall and being made of a material non-permeable to gases and contamination.

7. A method according to claim 5, wherein gas is removed from the second chamber, the composition of the gas removed being adapted to provide the particular partial pressure of the selected gas in the first chamber, and the gases removed from the second chamber being carried from the second chamber through transit means, a part of said transit means being in contact with the second chamber walls and being made of a material being non-permeable to gases and contamination.

8. A method according to claim 1, wherein the selected gas is a gas which is present in the ambient atmosphere at a partial pressure higher than the predetermined partial pressure of the selected gas species in the first chamber.

9. A method according to claim 1, wherein the antiseptic, a-septic, sterile or in other way other levels of contaminated environment in the first chamber is an environment containing contaminants, which is present in the ambient atmosphere at a pollution level substantially higher than a predetermined pollution level of the antiseptic, a-septic, sterile or in other way other levels of contaminated environment in the first chamber.

10. A method according to claim 1, wherein the material is biological material, including biological analogue material, cells and cell components.

11. A method for performing, at a particular partial pressure of a selected gas species in a gaseous atmosphere or at a particular total gas pressure of a gaseous atmosphere, said housing comprising first chamber walls defining a first chamber containing a gaseous atmosphere and second chamber walls defining a second chamber substantially enclosing the first chamber, the second chamber containing a gaseous atmosphere between said first and second chamber walls, and said operation being performed in the said first chamber while
a) the partial pressure of the selected gas species or the total gas pressure in the atmosphere of the second chamber is lower than the partial pressure of the selected gas species or the total gas pressure, respectively, in the gaseous atmosphere in the first chamber, and
b) the partial gas pressure of the selected gas species or the total gas pressure in the atmosphere of the second chamber is lower than the partial pressure of the selected species or the total gas pressure, respectively, of the gaseous atmosphere in an adjacent surrounding space,
c) the partial pressure of the selected gas species of the first chamber is lower than the partial pressure of the selected gas species in the gaseous atmosphere in the adjacent surrounding space, or the total gas pressure in the atmosphere of the first chamber is lower than the total gas pressure in the gaseous atmosphere in the adjacent surrounding space, and
d) materials and/or devices for carrying out the operation is carried through to the first chamber from the adjacent surrounding space through the second chamber walls, through the second chamber and through the first chamber walls along transit means in at least the first chamber wall, preferably along transit means in both the first chamber walls and the second chamber walls, in such a way that no gas from at least the second chamber is capable of migrating from the second chamber through the transit means in the first chamber walls to the first chamber, and
e) the carrying through taking place through transit means capable of keeping the materials between the carrying through from the adjacent surroundings through the second chamber walls to the transit means and the carrying through from the transit means through the first chamber walls to the first chamber.

12. A method according to claim 11, wherein the gaseous atmosphere of the adjacent surrounding space is air of the ambient atmosphere.

13. A method according to claims 11, wherein the operation is performed at a particular partial pressure of a selected gas species in the atmosphere of the first chamber, the ratio between the partial pressure of the selected gas species in the second chamber and the partial pressure of the selected gas species in the first and in the adjacent surrounding space chamber being at the most 1.00, e.g. at the most 0.99 such as at the most 0.97, e.g. at the most 0.95 such as at the most 0.90.

14. A method according to claim 13, wherein a number of gases are supplied to the first chamber, the composition of gases supplied being adapted to provide the particular pressure in the first chamber, and the gases supplied to the first chamber being carried through to the first chamber through transit means, a part of said transit means being in contact with the first chamber wall and being made of a material non-permeable to gases and contamination.

15. A method according to claim 13, wherein gas is removed from the second chamber, the composition of the gas removed being adapted to provide the particular partial pressure of the selected gas in the first chamber, and the gases removed from the second chamber being carried from the second chamber through transit means, a part of said transit means being in contact with the second chamber walls and being made of a material being non-permeable to gases and contamination.

16. A method according to claim 11, wherein the selected gas is a gas which is present in the ambient atmosphere at a partial pressure higher than the predetermined partial pressure of the selected gas species in the first chamber.

17. A method according to claim 11, wherein the antiseptic, a-septic, sterile or in other way other levels of contaminated environment in the first chamber is an environment containing contaminants, which is present in the ambient atmosphere at a pollution level substantially higher than a predetermined pollution level of the antiseptic, a-septic, sterile or in other way other levels of contaminated environment in the first chamber.

18. A method according to claim 11, wherein the material is biological material, including biological analogue material, cells and cell components.

19. A method for performing, in a particular antiseptic, a-septic or sterile environment, an operation in a housing comprising performing the operation in a housing comprising first chamber walls defining a first chamber containing an antiseptic, an a-septic, a sterile or in other way other levels of contaminated environment, the operation being performed in the said first chamber while
a) the antiseptic, a-septic, sterile or in other way other levels of contaminated environment of the first chamber is less polluted than the degree of pollution in any adjacent surrounding space or the antiseptic, a-septic, sterile or in other way other levels of contaminated environment of a selected part of the first chamber is less polluted than the degree of pollution in other parts of the first chamber, and
b) materials and/or devices for carrying out the operation is carried through to the first chamber from the adjacent surrounding space through the first chamber wall along transit means in the first chamber walls in such a way that no contamination from at least the adjacent surrounding space is capable of migrating from the adjacent surrounding space through the transit means in the first chamber walls to the first chamber.
c) the carrying through taking place through an air lock, said air lock being provided with a carrousel for transferring material and/or devices into the first chamber, said carrousel being angularly displaced during rotating from a first angular position where materials and/or devices are placed in the carrousel to a second angular position where the materials and/or devices are removed from the carrousel and placed in the first chamber.

20. A method according to claim 19, wherein the operation is performed at a particular partial pressure of a selected gas species in the atmosphere of the first chamber, the ratio between the partial pressure of the selected gas species in the second chamber and the partial pressure of the selected gas species in the first and in the adjacent surrounding space chamber being at the most 1.00, e.g. at the most 0.99 such as at the most 0.97, e.g. at the most 0.95 such as at the most 0.90.

21. A method according to claim 20, wherein a number of gases are supplied to the first chamber, the composition of gases supplied being adapted to provide the particular pressure in the first chamber, and the gases supplied to the first chamber being carried through to the first chamber through transit means, a part of said transit means being in contact with the first chamber wall and being made of a material non-permeable to gases and contamination.

22. A method according to claim 20, wherein gas is removed from the second chamber, the composition of the gas removed being adapted to provide the particular partial pressure of the selected gas in the first chamber, and the gases removed from the second chamber being carried from the second chamber through transit means, a part of said transit means being in contact with the second chamber walls and being made of a material being non-permeable to gases and contamination.

23. A method according to claim 19, wherein the selected gas is a gas which is present in the ambient atmosphere at a partial pressure higher than the predetermined partial pressure of the selected gas species in the first chamber.

24. A method according to claim 19, wherein the antiseptic, a-septic, sterile or in other way other levels of contaminated environment in the first chamber is an environment containing contaminants, which is present in the ambient atmosphere at a pollution level substantially higher than a predetermined pollution level of the antiseptic, a-septic, sterile or in other way other levels of contaminated environment in the first chamber.

25. A method according to claim 19, wherein the material is biological material, including biological analogue material, cells and cell components.

26. A method for performing, in a particular antiseptic, a-septic, sterile or in other way other levels of contaminated environment, an operation in a housing, said housing comprising first chamber walls defining a first chamber containing an antiseptic, an a-septic, sterile or in other way other levels of contaminated environment and second chamber walls defining a second chamber substantially enclosing the first chamber, the second chamber containing an antiseptic, an a-septic, sterile or in other way other levels of contaminated environment between said first and second chamber walls, the operation being performed in the said first chamber while
a) the partial pressure of the selected gas species or the total gas pressure in the atmosphere of the second chamber is lower than the partial pressure of the selected gas species or the total gas pressure, respectively, in the gaseous atmosphere in the first chamber, and
b) the antiseptic, a-septic, sterile or in other way other levels of contaminated environment of the first chamber is less polluted than the degree of pollution in the second chamber or the antiseptic, a-septic, sterile or in other way other levels of contaminated environment of a selected part of the first chamber is less polluted than the degree of pollution in other parts of the first chamber, and
c) the antiseptic, a-septic, sterile or in other way other levels of contaminated environment of the second chamber is less polluted than the degree of pollution in any adjacent surrounding space or the antiseptic, a-septic, sterile or in other way other levels of contaminated environment of a selected part of the second chamber is less polluted than the degree of pollution in other parts of the second chamber, and
d) materials and devices for carrying out the operation is carried through to the first chamber from the adjacent surrounding space through the second chamber walls, through the second chamber and through the first chamber walls along transit means in at least the first chamber wall, preferably along transit means in both the first chamber walls and the second chamber wall, in such a way that no gas from at least the second chamber is capable of migrating from the second chamber through the transit means in the first chamber walls to the first chamber.

27. A method according to claim 26, wherein the operation is performed at a particular partial pressure of a selected gas species in the atmosphere of the first chamber, the ratio between the partial pressure of the selected gas species in the second chamber and the partial pressure of the selected gas species in the first and in the adjacent surrounding space chamber being at the most 1.00, e.g. at the most 0.99 such as at the most 0.97, e.g. at the most 0.95 such as at the most 0.90.

28. A method according to claim 27, wherein a number of gases are supplied to the first chamber, the composition of gases supplied being adapted to provide the particular pressure in the first chamber, and the gases supplied to the first chamber being carried through to the first chamber through transit means, a part of said transit means being in contact with the first chamber wall and being made of a material non-permeable to gases and contamination.

29. A method according to claim 27, wherein gas is removed from the second chamber, the composition of the gas removed being adapted to provide the particular partial pressure of the selected gas in the first chamber, and the gases removed from the second chamber being carried from the second chamber through transit means, a part of said transit means being in contact with the second chamber walls and being made of a material being non-permeable to gases and contamination.

30. A method according to claim 26, wherein the selected gas is a gas which is present in the ambient atmosphere at a partial pressure higher than the predetermined partial pressure of the selected gas species in the first chamber.

31. A method according to claim 26, wherein the antiseptic, a-septic, sterile or in other way other levels of contaminated environment in the first chamber is an environment containing contaminants, which is present in the ambient atmosphere at a pollution level substantially higher than a predetermined pollution level of the antiseptic, a-septic, sterile or in other way other levels of contaminated environment in the first chamber.

32. A method according to claim 26, wherein the material is biological material, including biological analogue material, cells and cell components.

33. A housing, in particular for housing a material and/or device while an operation involving the material is performed, the housing comprising first chamber walls defining a first chamber containing a first gaseous atmosphere, and second chamber walls defining a second chamber between said first and second chamber walls, said second chamber walls substantially enclosing the first chamber and containing a second gaseous atmosphere, and said housing comprising
a) means for maintaining the partial pressure of a selected gas species or the total gas pressure in the atmosphere of the second chamber lower than the partial pressure of the selected gas species or the total gas pressure, respectively, in the gaseous atmosphere in the first chamber,
b) means for maintaining the partial gas pressure of the selected gas species or the total gas pressure in the atmosphere of the second chamber lower than the partial pressure of the selected species or the total gas pressure, respectively, of the gaseous atmosphere in an adjacent surrounding space,
c) means for maintaining the partial pressure of the selected gas species of the first chamber lower than the partial pressure of the selected gas species in the gaseous atmosphere in the adjacent surrounding space, or means for maintaining the total gas pressure in the atmosphere of the first chamber lower than the total gas pressure in the gaseous atmosphere in the adjacent surrounding space, and
d) means for carrying through materials and devices for carrying out the operation to the first chamber from the adjacent surrounding space through the second chamber walls, through the second chamber and through the first chamber walls along transit means in at least the first chamber wall, preferably along transit means in both the first chamber walls and the second chamber wall, in such a way that no gas from at least the second chamber is capable of migrating from the second chamber through the transit means in the first chamber walls to the first chamber.

34. A housing according to claim 33, where the transit means is capable of carrying through a non-gaseous material or device from the adjacent surrounding space to the first chamber.

35. A housing according to claim 34, which is adapted for transferring biological material or material analogous thereto, including living cells and cell components from the adjacent surrounding space to the first chamber, while performing operations in the first chamber on other material analogous thereto.

36. A housing according to claim 33, where the transit means is capable of carrying through a gaseous material from the adjacent surrounding space to the first chamber.

37. A housing according to claim 36, which is adapted for transferring biological material or material analogous thereto, including living cells and cell components from the adjacent surrounding space to the first chamber, while performing operations in the first chamber on other material analogous thereto.

38. A housing according to claim 33, where the second chamber or an intermediate chamber within the second chamber is filled with a number of liquids with gas carrying properties for carrying in the number of liquids one or more selected gases such as oxygen, said number of liquid being selected from the group consisting of perfluorocarbon, silicone and fluorosilicone, perfluorodecalin, perfluorodimethylcyclohexane, perfluorotrimethylcyclohexane, perfluoroethylcyclohexane, perfluorooctane, perfluoroperhydrophenanthrene, perfluoromethyladamantane, perfluorodimethyladamantane, the highly viscous perfluoropolyether liquids Krytox TLF7067 and 6354, and dimethylsiloxane liquids of a variety of viscosities perfluoromethyldecaline, perfluorofluorene, perfluorotributylamine, the perfluoropolyether K-6 hexamer, trifluoropropylmethylsiloxane (fluorosilicone), and diphenyldimethylsiloxane, hydrogen-rich monohydroperfluorooctane, alumina-treated perfluorooctane.

39. A housing according to claim 33, wherein the adjacent surrounding space is the ambient atmosphere.

40. A housing according to claim 33, where the transit means comprises an air lock, said air lock being provided with a carrousel for transferring material and/or devices into the first chamber, said carrousel being capable of being angularly displaced during rotating from a first angular position where materials and/or devices are placed in the carrousel to a second angular position where the materials and/or devices are removed from the carrousel and placed in the first chamber.

41. A housing according to claim 33, where a top plate and/or a bottom plate of the carrousel is provided with tenons extending outwards from the top plate and/or the bottom plate, that a top guide plate and/or a bottom guide plate is provided above and below, respectively, the top plate and the bottom plate of the carrousel, and where the top guide plate and/or the bottom guide plate is provided with grooves through which the tenons extend, said grooves controlling the linear displacement and the angular displacement of the carrousel.

42. A housing according to claim 33, wherein opposite parts of the first and second chamber walls are transparent, and wherein the transparent wall parts allow displaying of materials and/or devices within the first chamber from a position outside the second chamber walls, and where the transparent walls are provided with lenses so that a magnification from the inside of the first chamber of any materials and/or devices to the adjacent surrounding space is established.

43. A housing according to claim 33, wherein the second chamber between the first chamber walls and the second chamber walls is capable of containing a heat transmission fluid, the fluid being a gas or a liquid, and where the heat transmission fluid is capable of accumulating heat from the first chamber wall, alternatively where the heat transmission fluid is capable of transmitting heat to the first chamber walls.

44. Suspension means for suspending furnishings within the housing according to claim 33, wherein a number of the suspension means are provided along inner walls of the housing, said suspension means being substantially T-shaped and extending laterally outwards from the inner wall with the base of the T-shape being connected to the inner wall and the top bar of the T-shape being distant from the inner wall, and said T-shaped suspension means being intendec for co-oprating with corresponding key-hole shaped holes provided in furnishings intended for being suspended by the T-shaped suspension means along the inner walls of the housing.

45. Suspension means according to claim 44, wherein the top bar of the substantially T-shaped suspension means have a trapezoidal shape with the shorter top line of the trapezoidal shape being provided at the stem of the T-shape and the longer bottom line of the trapezoidal shape being provided distant from the stem of the T-shape.

46. Shelf for being suspended in the housing according to claim 33, wherein a number of plates constituting shelves are intended for being provided in the housing, preferably intended for being provided suspended along inner walls of the housing, where said shelves are provided with holes in horizontal bearing surfaces of the shelves, and where edges of the holes preferably are chamfered.

47. A shelf according to claim 46, wherein a number of shelves are intended for being suspended along inner walls of the housing, said shelves having substantially key-hole shaped holes provided in suspension surfaces, said holes intended for co-operation with corresponding substantially T-shaped suspension means in such a manner that the top bar of the T-shape initially is inserted into the circular shape of the keyhole, and that the stem of the T-shape subsequently is displaced along the oblong part of the key-hole shape to the upmost part of the oblong part.

48. A casing constituting incubators for being suspended, alternatively for being supported, in the housing according to claim 33, wherein a number of casings constituting incubators are intended for being provided in the housing, preferably intended for being provided suspended along inner walls of the housing, alternatively intended for being supported on shelves inside the housing, where said incubators are provided with a number of inlets and outlets, preferably doors, in at least vertical surfaces of the incubators, alternatively in at least top surfaces of the incubators, and where said inlets and outlets preferably are provided with windows.

49. A casing according to claim 48, said casing constituting an incubator being provided with a number of shelves, preferably shelves being separate from the incubator itself, alternatively shelves being integral with the incubator itself, wherein a number of plates constituting the number of shelves are intended for being provided in the incubator, preferably intended for being provided suspended at railings inner walls of the incubator, where said shelves are provided with holes in horizontal bearing surfaces of the shelves, and where edges of the holes preferably are chamfered.

50. A number of casings according to claim 48, said number of casings constituting individual incubators, preferably individual incubators being separate from each other, alternatively individual incubators being integral with each other, wherein a number of casings constituting the number of individual incubators are intended for being provided in a common incubator, alternatively intended for being provided individually within the working chamber, and where said individual incubators each have means for individually controlling at least the humidity, possibly also other parameters, of gas species and of a gaseous atmosphere inside the individual incubators.

51. A casing according to claim 48, wherein a number of casings constituting incubators are intended for being suspended along inner walls of the housing, said incubators having substantially key-hole shaped holes provided in suspension surfaces, said holes intended for co-operation with corresponding substantially T-shaped suspension means in such a manner that the top bar of the T-shape initially is inserted into the circular shape of the keyhole, and that the stem of the T-shape subsequently is displaced along the oblong part of the key-hole shape to the upmost part of the oblong part.

52. A casing according to claim 51, said casing constituting an incubator being provided with a number of shelves, preferably shelves being separate from the incubator itself, alternatively shelves being integral with the incubator itself, wherein a number of plates constituting the number of shelves are intended for being provided in the incubator, preferably intended for being provided suspended at railings inner walls of the incubator, where said shelves are provided with holes in horizontal bearing surfaces of the shelves, and where edges of the holes preferably are chamfered.

53. Table for being supported in the housing according to claim 33, wherein a number of plates constituting tables are intended for being provided in the housing, preferably intended for being provided supported at an inner bottom of the housing, where said tables are provided with holes in horizontal bearing surfaces of the tables, and where edges of the holes preferably are chamfered.

54. A housing according to claim 33, wherein the second chamber constitutes one continuous space, and wherein the second chamber substantially encloses the first chamber walls except for transit means extending through the second chamber walls, through the second chamber and through the first chamber walls.

55. A housing according to claim 33, wherein the depth of the wall is between 1-1000 mm, such as between 1-500 mm, such as between 2-350 mm, such as between 2-200 mm, e.g. 2-20 mm.

56. A housing according to claim 54, wherein the depth of the wall is between 1-1000 mm, such as between 1-500 mm, such as between 2-350 mm, such as between 2-200 mm, e.g. 2-20 mm.

57. A housing according to claim 33, wherein the ratio between the volume of the second chamber and the volume of the first chamber is in the range of 10:1-1:1000 such as 1:1-1:300, e.g. 1:10-1:100.

58. A housing according to claim 54, wherein the ratio between the volume of the second chamber and the volume of the first chamber is in the range of 10:1-1:1000 such as 1:1-1:300, e.g. 1:10-1:100.

59. A housing according to claim 33, wherein the temperature within the first chamber may be adjusted in the range of −200° C.-130° C. such as −100° C.-120° C., e.g. 0° C.-100° C.

60. A housing according to claim 54, wherein the temperature within the first chamber may be adjusted in the range of −200° C.-130° C. such as −100° C.-120° C., e.g. 0° C.-100° C.

61. A garment, in particular a glove, comprising a double layered flexible material comprising an inner layer of a flexible material and an outer layer of a flexible material, the inner layer and the outer layer defining a space there-between containing a gaseous atmosphere and means for maintaining a lower total pressure of a gas or a lower partial pressure of a selected gas species within the space defined by the inner-layer and the outer layer compared to the adjacent surrounding space of the garment, and the inner layer being shaped like a sleeve, preferably a sleeve with a cuff, and the outer layer being shaped like a glove.

62. A garment according to claim 61, the garment comprising an intermediate layer of flexible material, the intermediate layer being provided in the space between the outer layer and the inner layer of the garment, said intermediate layer being provided with means for controlling the gas species and the gaseous atmosphere in the space between the inner layer and the outer layer of the garment, said controlling being controlling a number of the following parameters of the gas species and of the gaseous atmosphere: composition of gas species, temperature of gaseous atmosphere, partial pressure of gas species, pressure of gaseous atmosphere, humidity of gaseous atmosphere.

63. A garment, in particular a glove, comprising a double layered flexible material comprising an inner layer of a flexible material and an outer layer of a flexible material, the inner layer and the outer layer defining a space there-between containing a gaseous atmosphere and means for maintaining a lower total pressure of a gas or a lower partial pressure of a selected gas species within the space defined by the inner layer and the outer layer compared to the adjacent surrounding space of the garment, and the inner layer being shaped like a diaphragm and the outer layer being shaped like a glove.

64. A garment according to claim 63, the garment comprising an intermediate layer of flexible material, the intermediate layer being provided in the space between the outer layer and the inner layer of the garment, said intermediate layer being provided with means for controlling the gas species and the gaseous atmosphere in the space between the inner layer and the outer layer of the garment, said controlling being controlling a number of the following parameters of the gas species and of the gaseous atmosphere: composition of gas species, temperature of gaseous atmosphere, partial pressure of gas species, pressure of gaseous atmosphere, humidity of gaseous atmosphere.

65. A garment box, in particular a garment box for a glove, being intended for placing in an aperture of a workbench, said garment box comprising an inner cylindrical casing and an outer cylindrical casing, the outer cylindrical casing being provided circumferentially around the inner cylindrical casing, said inner casing along an orifice being provided with an outer layer of a flexible material and said outer casing being along an orifice being provided with an inner layer of a flexible material, and where the inner layer is shaped like a glove and the outer layer is shaped like a diaphragm.

66. A garment box according to claim 65, where at least an inner passage is provided with a cover, preferably a sealing foil, said cover being detachable, and where the inner cover is intended for providing a sealing up of the first chamber when the garment box is placed in the apertures of the workbench and before the garment in the garment box is being put to use.

67. A garment box according to claim 66, where also an outer passage is provided with a sealing foil, said sealing foil being detachable, and where the inner sealing foil in combination with the outer sealing foil is intended for providing a sealing up of the interior of the inner casing and the outer casing before the garment in the garment box is buing put to use.

68. A garment box according to claim 67, where the garment in the garment box is sterilised before or after the sealing outer foil and inner foil is attached to the passages of the garment box, and that the garment is kept sterilised when the sealing outer foil and inner foil is attached to the passages of the garment box.

69. Use of a housing according to claim 33 for operating biological systems.

70. Use of a housing according to claim 33 for operating electronic systems.
